(19) United States
(12) Patent Application Publication
(10) Pub. No.: US 2016/0350953 A1
(43) Pub. Date: Dec. 1, 2016

(54) FACILITATING ELECTRONIC COMMUNICATION WITH CONTENT ENHANCEMENTS

(71) Applicant: Facebook, Inc., Menlo Park, CA (US)

(72) Inventors: Andrea Mittelstaedt, Mountain View, CA (US); Richard Kenneth Zadorozny, Menlo Park, CA (US); Evan Cooperman Litvak, San Francisco, CA (US); Willie Arthur Franklin, San Francisco, CA (US)

(21) Appl. No.: 14/724,630

(22) Filed: May 28, 2015

(51) Int. Cl. G06T 11/60; G06F 3/0484; H04L 29/08; G06F 17/22; H04L 12/58; G06F 3/0482; G06F 17/24

(52) U.S. Cl. CPC G06T 11/60; G06F 3/0482; G06F 3/04842; G06F 17/24; G06F 17/2235; H04L 51/043; H04L 67/306

(57) ABSTRACT

One or more embodiments of the disclosure include an electronic communication system that applies a content enhancement to a digital content item and sends an electronic communication containing an enhanced digital content item. Specifically, the electronic communication system can detect enhancement selection information related to the electronic communication and, based on the enhancement selection information, suggest one or more context specific content enhancements. For example, the electronic communication system can analyze enhancement selection information related to features of a digital content item, characteristics of a user, information from a social graph, and/or other information to suggest one or more content enhancements to the digital content item, apply the one or more content enhancements to the digital content item, and send an enhanced digital content item to a recipient in an electronic communication.

### BACKGROUND

1. Technical Field

One or more embodiments relate to systems and methods for providing electronic communication. More specifically, one or more embodiments of the present invention relate to systems and methods of enhancing content of an electronic communication.

2. Background and Relevant Art

Recent years have seen a rapid increase in opportunities to communicate using computing devices. Individuals have increased access to smartphones, tablets, laptops, personal computers, smart watches, smart televisions, or other computing devices that allow individuals to participate in a variety of forms of digital communication, including (among other methods), e-mail, instant messaging, and social network posts. In addition, assorted modes of digital communication allow individuals to exchange digital information in various forms, including, text, images, audio, and/or video.

With the growing prevalence of digital communication capabilities, individuals are increasingly looking for opportunities to find new, individualized, customized, and entertaining means of digital expression. Indeed, although users have increased access to a variety of digital communication methods, many of those methods rely on simple text, images, audio, or videos that many users find generic and mundane. Therefore, many users seek avenues for digital communication that go beyond these generic media forms.

Some conventional electronic communication systems seek to provide opportunities for more entertaining, efficient, and creative means of expression by allowing users to send symbols (e.g., emoticons). By using symbols, conventional systems permit users to express themselves outside the traditional paradigm of simple text, images, or video. A symbol, for example, can allow a user to convey an idea without taking the time to enter unnecessary text while communicating in a manner that is often more enjoyable or entertaining for the user and the recipient.

Although using symbols can provide users with another option for digital communication, a number of problems exist with conventional systems that utilize symbols within electronic communication. For example, conventional systems that offer the use of symbols commonly limit users to only a list of pre-defined symbols. A pre-defined list of symbols, however, limits a user's ability to customize or personalize a digital communication. Thus, pre-defined symbols found within conventional systems often fail to provide users with an opportunity to express a wide range of thoughts or emotions.

Furthermore, due to the ease and efficiency of digital communication, users often send and receive a large number of electronic communications on a daily basis. Thus, although users desire the ability to personalize electronic communication to more accurately express their thoughts, users also desire to do so easily and efficiently. Many conventional systems that provide the ability to communicate with emoticons, however, are often complicated to navigate and use. Indeed, as conventional systems attempt to add more and more features, the amount of options in conventional systems can become confusing and complicated. Accordingly, conventional systems that utilize symbols can be frustrating and time-consuming for users.

Due to the above frustrations, alternative forms of electronic communication (e.g., emoticons) within conventional systems are often un-utilized (or under-utilized) because users do not take the time needed to use the additional communication feature. Moreover, in many conventional systems, the process required to use alternative forms of electronic communication is not intuitive, and therefore, many users are ignorant of (or simply forget about) the option to use the alternative forms. This problem is only exacerbated in conventional systems that offer multiple expressive features within the same application. As such, many users find conventional systems unenjoyable and are seeking new, alternative means of effectively and efficiently composing and sending electronic communication that can accurately express a wide range of thought and emotion.

Accordingly, there are a number of considerations to be made in improving electronic communications.

### SUMMARY

One or more embodiments described below provide benefits and/or solve one or more of the foregoing or other problems in the art with systems and methods for facilitating electronic communication using one or more content enhancements. In particular, one or more embodiments include systems and methods that can identify, present, modify, and transmit one or more content enhancements in conjunction with a digital content item within an electronic communication. Moreover, one or more embodiments include systems and methods that customize content enhancements available to a user. Specifically, systems and methods can identify enhancement selection information regarding a user's interest to identify one or more context specific content enhancements.

Furthermore, one or more embodiments include systems and methods that utilize (and communicate across) multiple client applications. Accordingly, systems and methods can utilize multiple applications to inform and remind users regarding available features and to efficiently present, apply, and send content enhancements with digital content items. For example, in one or more embodiments, the systems and methods disclosed receive an electronic communication intended for a recipient via a communication application and identify content within the electronic communication associated with a content enhancement application. In response, the systems and methods can provide an option to compose a response to the electronic communication using the content enhancement application, while utilizing the communication application to send the response that includes content enhancements with the digital content item in an electronic communication.

The systems and methods disclosed solve or mitigate many of the problems described above with regard to conventional electronic communication systems. By presenting context specific content enhancements—and allowing users to select and modify content enhancements in conjunction with other digital content items—one or more embodiments include systems and methods that permit users to send electronic communications that more accurately express thought and emotion, that are more entertaining, and that go beyond mundane media items.

In addition, in one or more embodiments, the systems and methods allow users to customize electronic communications to their particular surroundings and communicate in a more personal manner. For example, a user at a particular location can capture a digital content item specific to their location, and, in response, the systems and methods can detect the location and present context specific content enhancements. The user can select desired content enhancements and send the desired content enhancements together with the digital content item to friends or family. Thus, the user can effectively and efficiently customize an electronic communication, and do so in a manner utilizing an electronic solution that is more entertaining, personal, and accurate than conventional systems.

Moreover, one or more embodiments include systems and methods that assist users to utilize content enhancements by informing users of available content enhancement features. In particular, the systems and methods can provide a user with notifications through a variety of applications to remind and inform users of available content enhancement features.

Moreover, in one or more embodiments, the systems and methods provide a content enhancement application separate from a communication application. As such, the systems and methods can provide users with a simple and intuitive user interface in a communication application, while also seamlessly integrating with a content enhancement application upon detection that the user wishes to utilize content enhancement features. Because the applications operate seamlessly with each other (e.g., transferring digital content between applications with minimal user input), the systems and methods allow a user to easily and efficiently incorporate content enhancement features into electronic communications sent via the communication application.

Additional features and advantages of will be set forth in the description which follows, and in part will be obvious from the description, or may be learned by the practice of such exemplary embodiments. The features and advantages of such embodiments may be realized and obtained by means of the instruments and combinations particularly pointed out in the appended claims. These and other features will become more fully apparent from the following description and appended claims, or may be learned by the practice of such exemplary embodiments as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof that are illustrated in the appended drawings. It should be noted that the figures are not drawn to scale, and that elements of similar structure or function are generally represented by like reference numerals for illustrative purposes throughout the figures. Understanding that these drawings depict only typical embodiments of the invention and are not therefore to be considered to be limiting of its scope, the invention will be described and explained with additional specificity and detail through the use of the accompanying drawings.

FIG. 1 illustrates a schematic diagram of a network environment in which the methods and systems disclosed herein may be implemented in accordance with one or more embodiments.

FIG. 2 illustrates a schematic diagram of an electronic communication system in accordance with one or more embodiments.

FIG. 3A illustrates a user interface in accordance with one or more embodiments.

FIG. 3B illustrates a user interface showing a plurality of representations of content enhancements in accordance with one or more embodiments.

FIG. 3C illustrates a user interface with content enhancements in accordance with one or more embodiments.

FIG. 3D illustrates a user interface with modified content enhancements in accordance with one or more embodiments.

FIG. 4A illustrates a user interface with a list of contacts in accordance with one or more embodiments.

FIG. 4B illustrates a user interface with an electronic communication containing a digital content item with content enhancements in accordance with one or more embodiments.

FIG. 4C illustrates a user interface with an electronic communication containing a digital content item with a content enhancement in accordance with one or more embodiments.

FIG. 5 illustrates a user interface for capturing a digital content item in accordance with one or more embodiments.

FIG. 6A illustrates a user interface in accordance with one or more embodiments.

FIG. 6B illustrates a user interface with a video content enhancement in accordance with one or more embodiments.

FIG. 6C illustrates a user interface with a modified video content enhancement in accordance with one or more embodiments.

FIG. 6D illustrates a user interface with a modified video content enhancement and modified digital content item in accordance with one or more embodiments.

FIG. 6E illustrates a user interface with a video digital content item and content enhancement in accordance with one or more embodiments.

FIG. 6F illustrates a user interface capturing a video content enhancement in accordance with one or more embodiments.

FIG. 6G illustrates a user interface with a video digital content item and a captured content enhancement in accordance with one or more embodiments.

FIG. 7A illustrates a user interface in accordance with one or more embodiments.

FIG. 7B illustrates a user interface with an audio digital content item and audio content enhancement in accordance with one or more embodiments.

FIG. 7C illustrates a user interface with an audio digital content item and a modified audio content enhancement in accordance with one or more embodiments.

FIG. 8 illustrates a user interface with a video digital content item, a video content enhancement, and an audio content enhancement in accordance with one or more embodiments.

FIG. 9 illustrates a flow chart of a method of facilitating an electronic communication in accordance with one or more embodiments.

FIG. 10 illustrates a flow chart of a method of facilitating an electronic communication in accordance with one or more embodiments.

FIG. 11 illustrates a block diagram of an exemplary computing device in accordance with one or more embodiments.

FIG. 12 illustrates a network environment of a social-networking system according one or more embodiments.

FIG. 13 illustrates an example social graph of a social networking system in accordance with one or more embodiments.

### DETAILED DESCRIPTION

One or more embodiments of the present invention include an electronic communication system that allows a user to enhance content to use within an electronic communication. In particular, in one or more embodiments, the electronic communication system can suggest, select, present, append, incorporate, and/or otherwise associate one or more content enhancements with a digital content item. Moreover, the electronic communication system can facilitate sending the digital content item that includes the content enhancement within an electronic communication to one or more other users.

In particular, in one or more embodiments the electronic communication system can determine that a user wants to compose an electronic communication that includes one or more content enhancements. In response, the electronic communication system identifies content enhancement selection information, determines content enhancement suggestions, and suggests one or more content enhancements based on the determined suggestions. For example, a content enhancement application can suggest one or more content enhancements (e.g., an image overlay) for a user to apply to a digital content item (e.g., a digital photo). Moreover, in one or more embodiments, the electronic communication system can apply the content enhancement to the digital content item, creating an enhanced digital content item, and send an electronic communication with the enhanced digital content item to a recipient.

To permit users to easily and quickly create electronic communications that include an enhanced digital content item, the electronic communication system can operate seamlessly (i.e., with no or limited user input) across numerous applications. Indeed, the electronic communication system can implicitly (i.e., without users being aware that they are opening or closing separate applications) utilize a communication application, a content enhancement application, a digital content application, a social messaging application, and/or other applications to facilitate electronic communication.

For instance, in one or more embodiments, the electronic communication system can receive an electronic communication via a communication application and identify information within the electronic communication corresponding to a content enhancement application. In the event the content enhancement application is not available on the client device, the electronic communication system can enable installation of the content enhancement application. Where the content enhancement application is available, the electronic communication system can allow the user to compose a response to the electronic communication using the content enhancement application.

To assist a user in accessing and sending content enhancements that are unique, enjoyable, and personal, the electronic communication system can collect, identify, and detect enhancement selection information related to an electronic communication. Enhancement selection information can identify a user's likely interest in one or more content enhancements. In one or more embodiments, for example, the electronic communication system can identify and suggest context specific content enhancements based on enhancement selection information. A user can select one or more content enhancements, based on a suggestion, and send an enhanced digital content item with an electronic communication to another device.

Another manner in which the electronic communication system can utilize enhancement selection information is to provide content enhancement templates. A template is a group of pre-configured content enhancements. In one or more embodiments, the electronic communication system can suggest a content enhancement template based on enhancement selection information. Templates can simultaneously customize an electronic communication in an entertaining way while further reducing the time required to utilize the electronic communication system.

In addition to providing a variety of content enhancements, the electronic communication system can also allow a user to customize a content enhancement. For example, the electronic communication system can modify (e.g., resize, move, rotate, change colors, etc.) a content enhancement. The electronic communication system can modify the content enhancement based on one or more features of the digital content item, based on user input, or based on some other factor. For example, in one or more embodiments, the electronic communication system can detect the contours of an object pictured in an image and resize, move, and/or rotate the content enhancement to match the size, location, and rotation of the object within the digital content item.

Although the electronic communication system can provide and modify a variety of content enhancements, the electronic communication system can also permit the user to create content enhancements. For example, the electronic communication system can permit a user to capture a photo and create a new content enhancement from that image. Similarly, the electronic communication system can capture user-modifications with regard to an image to create a video content enhancement. Thus, the electronic communication system permits a user to send electronic communications containing customized digital content items with a variety of customized content enhancements.

As used herein, the term “digital content item” or “digital content” refers to any digital media of any kind. For example, a digital content item can include, but is not limited to, any audio, video, image, or other digital media (in isolation or in combination). In one or more embodiments, for example, a digital content item can include a digital photo that a user captures using a camera on a computing device. Similarly, a digital content item can include an audio file that a user captures using a microphone on a computing device. A digital content item can originate from any source. For instance, a user can capture a digital content item with a computing device, receive a copy of a digital content item from a second device, or simply download a digital content item from the Internet.

As used herein, the term “content enhancement” refers to a modification or change to a digital content item. In one or more embodiments, for example, a content enhancement can include adding (e.g., in a digital overlay) and/or removing content to or from a digital content item. Moreover, a content enhancement can include modifying content within a digital content item. In particular, for example, a content enhancement can include, but is not limited to, an audio file, video file, image, symbol, animation (e.g., GIF), text, link, hyperlink, URL, button, icon, graphic, banner, field, object, recording, and/or any other digital file or data (in isolation or in combination).

For example, the electronic communication system can provide a content enhancement consisting of an image with text situated so that it appears on top of a digital content item captured by a client device. Similarly, the electronic communication system can provide a content enhancement comprising an audio file that is provided as an audio overlay to an existing audio or video digital content item. As another example, the electronic communication system can provide a content enhancement that includes an image that incorporates a link, or some other combination of content enhancements.

As used herein the term “application” refers to a set of computer instructions that, when executed by a processor associated with a computing device, causes the computer to perform a task. The term application can include a set of instructions in any form, including a program, library function, plug-in, script, or “app” for a mobile device. Moreover, applications can cause a computer to perform any number of tasks, including, capturing or accessing a digital content item, modifying a digital content item, and/or receiving and sending electronic communications that include a digital content item.

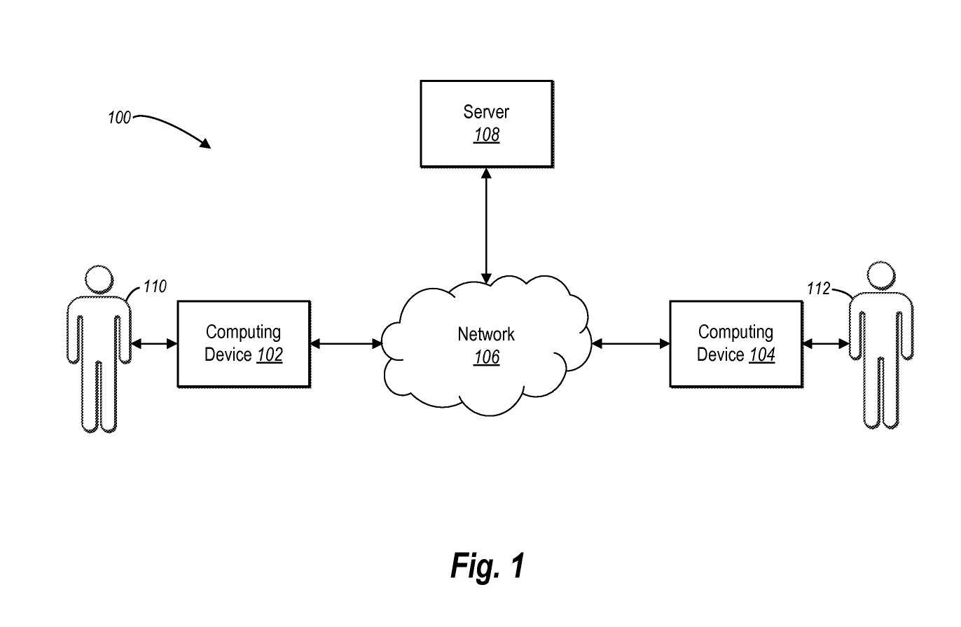

FIG. 1 is a schematic diagram illustrating an example system 100, within which one or more embodiments of an electronic communication system can be implemented. As illustrated in FIG. 1, system 100 can include computing device 102, computing device 104 (collectively “computing devices 102, 104), a network 106, and a server 108. The computing devices 102, 104, the network 106, and the server 108 may be communicatively coupled, as shown in FIG. 1. Although FIG. 1 illustrates a particular arrangement of the computing devices 102, 104, the network 106, and the server 108, various additional arrangements are possible. For example, the computing devices 102, 104 may directly communicate with the server 108, bypassing network 106. Or alternatively, the computing devices 102, 104 may directly communicate with each other.

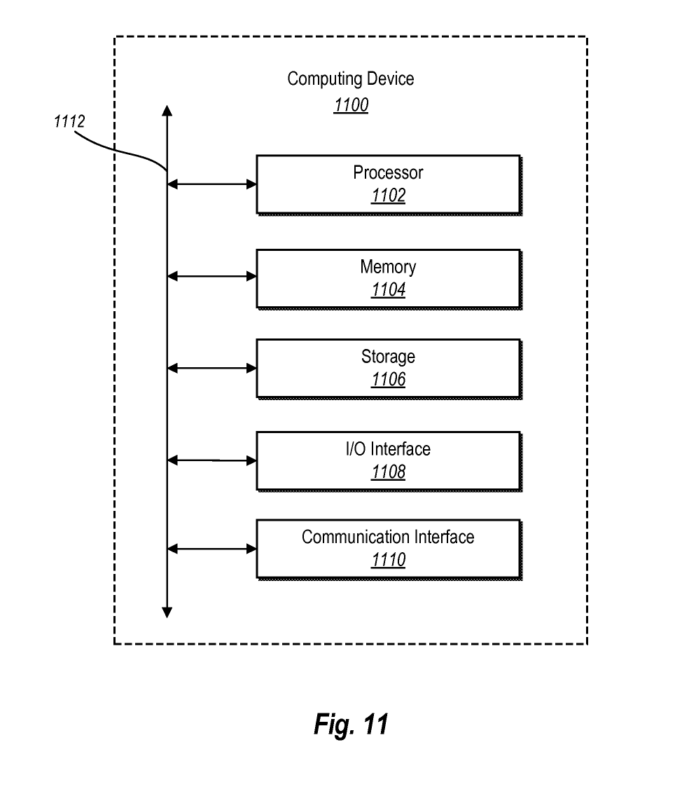

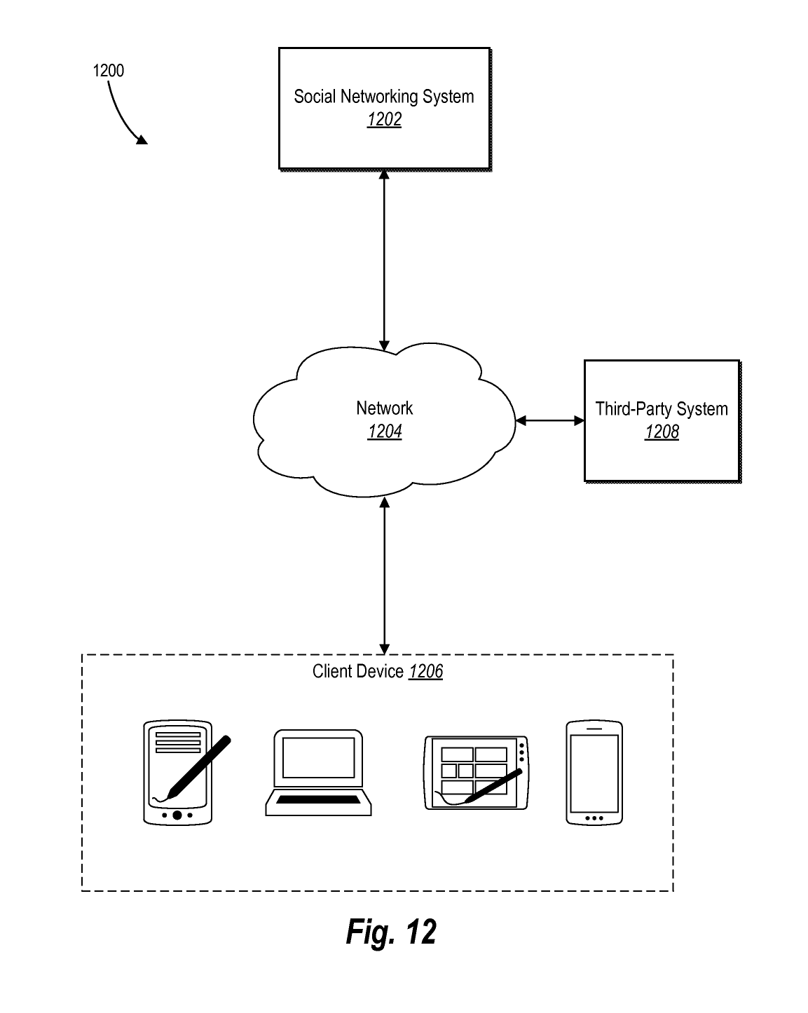

The computing devices 102, 104, the network 106, and the server 108 may communicate using any communication platforms and technologies suitable for transporting data and/or communication signals, including any known communication technologies, devices, media, and protocols supportive of remote data communications, examples of which will be described in more detail below with respect to FIGS. 11-12.

In addition, and as illustrated in FIG. 1, computing devices 102, 104 and server 108 may communicate via the network 106. The network 106 may represent a network or collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the network 106 may be any suitable network over which the computing device 102 may access the server 108 and/or the computing device 104, or vice versa. The network 106 will be discussed in more detail below with regard to FIGS. 11-12.

Server 108 may generate, store, receive, and transmit electronic communication data. For example, server 108 may receive an electronic communication from the computing device 102 and send the received electronic communication to the computing device 104. In particular, the server 108 can transmit electronic messages between one or more users of the system 100. In one example, server 108 can host a social network. In another example, the server 108 is a communication server, such as an instant message server. Regardless, server 108 can be configured to receive a wide range of electronic communication types, including but not limited to, text messages, instant messages, social-networking messages, social-networking posts, emails, and any other form of an electronic communication. Additional details regarding server 108 will be discussed below with respect to FIGS. 11-12.

In addition to the elements of system 100, FIG. 1 illustrates that a user 110 can be associated with the computing device 102, and that a user 112 can be associated with the computing device 104. For example, users 110, 112 may be individuals (i.e., human users). Although FIG. 1 illustrates only two users 110, 112, it is understood that system 100 can include a large number of users, with each of the users interacting with the system 100 through a corresponding number of computing devices. For example, the user 110 can interact with the computing device 102 for the purpose of composing and sending an electronic communication (e.g., instant message). The user 110 may interact with the computing device 102 by way of a user interface on the computing device 102. For example, the user 110 can utilize the user interface to cause the computing device 102 to create and send an electronic communication having a digital content item with one or more content enhancements to one or more of the plurality of users of the system 100.

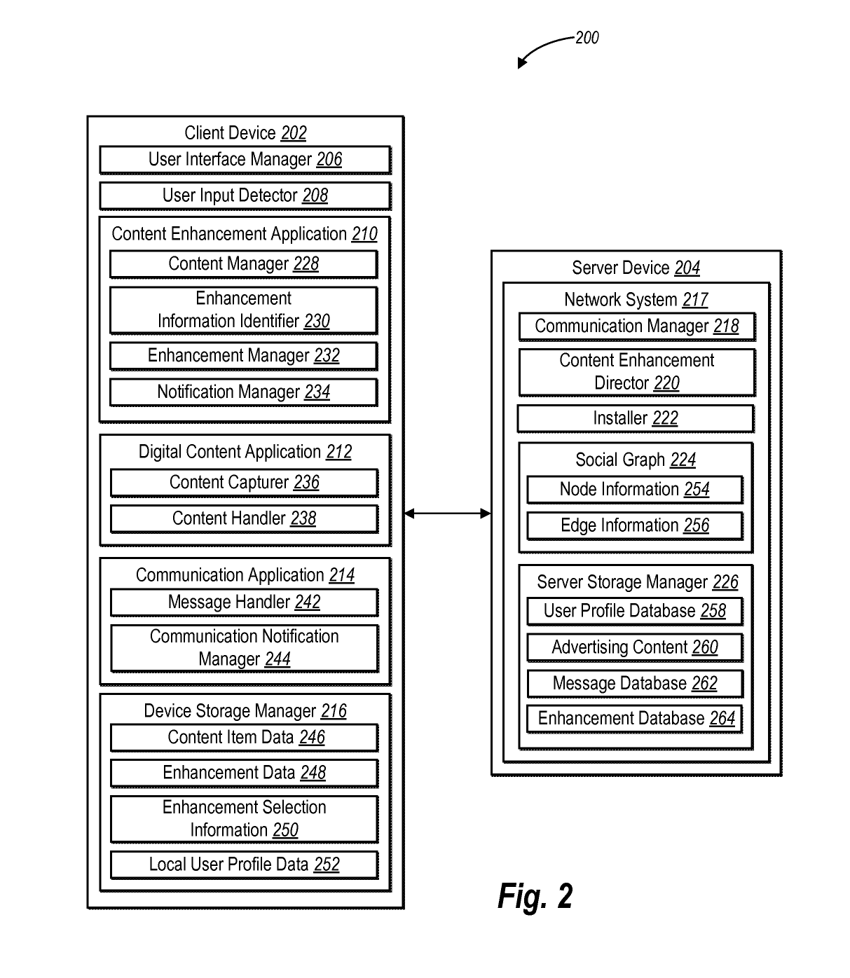

FIG. 2 illustrates an example embodiment of an electronic communication system 200 (or simply “communication system 200”) in accordance with one or more embodiments. For example, the communication system 200 can represent one or more embodiments of the system 100 explained above with respect to FIG. 1, and as such, communication system 200 can include one or more components, functions, and/or characteristics as discussed above with respect to system 100. For instance, the communication system 200 can be implemented in whole or in part on the computing device 102 or in whole or in part on the server 108. As shown, the communication system 200 may include, but is not limited to a client device 202 and a server device 204. In general, the communication system 200 can allow a user of the client device 202 to send or receive electronic communications containing one or more digital content items with one or more content enhancements to one or more additional users through the server device 204.

As shown in FIG. 2, the client device 202 can include, but is not limited to, a user interface manager 206; a user input detector 208; a content enhancement application 210 comprising various components 228-234, a digital content application 212 comprising various components 236-238, a communications application 214 comprising various components 242-244, and a device storage manager 216 that maintains content item data 246, enhancement data 248, enhancement selection information 250, and local user profile data 252.

Furthermore, as shown in FIG. 2, the server device 204 can include, but is not limited to, a network system 217 having a communication manager 218, a content enhancement director 220, an installer 222, a social graph 224 that includes node information 254 and edge information 256, and a server storage manager 226 that maintains a user profile database 258, advertising content 260, a message database 262, and an enhancement database 264.

Each of the components 206-226 of the communication system 200 and their corresponding components may be in communication with one another using any suitable communication technologies. It will be recognized that although components 206-226 and their corresponding elements are shown to be separate in FIG. 2, any of components 206-226 and their corresponding elements may be combined into fewer components, such as into a single facility or module, divided into more components, or configured into different components as may serve a particular embodiment.

The components 206-226 and their corresponding elements can comprise software, hardware, or both. For example, the components 206-226 and their corresponding elements can comprise one or more instructions stored on a computer-readable storage medium and executable by processors of one or more computing devices. When executed by the one or more processors, the computer-executable instructions of the communication system 200 can cause the client device 202 and/or server device 204 to perform the methods described herein. Alternatively, the components 206-226 and their corresponding elements can comprise hardware, such as a special purpose processing device to perform a certain function or group of functions. Additionally or alternatively, the components 206-226 and their corresponding elements can comprise a combination of computer-executable instructions and hardware.

Furthermore, the components 206-226 of the communication system 200 may, for example, be implemented as one or more stand-alone applications, as one or more modules of an application, as one or more plug-ins, as one or more library functions or functions that may be called by other applications, and/or as a cloud-computing model. Thus, the components 206-226 of the communication system 200 may be implemented as a stand-alone application, such as a desktop or mobile application. Furthermore, the components 206-226 of the communication system 200 may be implemented as one or more web-based applications hosted on a remote server. Alternatively or additionally, the components of the digital signature system 200 may be implemented in a suit of mobile device applications or “apps.”

As briefly mentioned, and as illustrated in FIG. 2, the client device 202 may contain a user interface manager 206. The user interface manager 206 can provide, manage, and/or control a graphical user interface (or simply “user interface”) for use with the communication system 200. In particular, the user interface manager 206 may facilitate presentation of information by way of an external component of the client device 202. For example, the user interface manager 206 may display a user interface by way of a display screen associated with the client device 202. The user interface may be composed of a plurality of graphical components, objects, and/or elements that allow a user to perform a function. The user interface manager 206 can present, via the client device 202, a variety of types of information, including text, images, video, audio, or other information. Moreover, the user interface manager 206 can provide a variety of user interfaces specific to any variety of functions, programs, applications, plug-ins, devices, operating systems, and/or components of the client device 202.

The user interface manager 206 can provide a user interface with regard to a variety of operations or applications. For example, the user interface manager can provide a user interface that facilitates composing, sending, or receiving an electronic communication containing a digital content item and one or more content enhancements (e.g., via the communication application 214). Similarly, the user interface manager 206 can generate a user interface that facilities providing, capturing, selecting, or otherwise interacting with a digital content item (e.g., via the digital content application 212). Moreover, the user interface manager 206 can provide a user interface that facilitates capturing, selecting, modifying or otherwise interacting with one or more content enhancements (e.g., via the content enhancement application 210). Additional details with respect to various example user interface elements will be further explained below.

The user interface manager 206 can communicate and operate in conjunction with any other component or element of the communication system 200. For example, based on a request from one or more applications, the user interface manager 206 can display icons, dialogue boxes, banners, buttons, pop-ups, or other elements that notify, remind, or inform a user regarding one or more features of the communication system 200. In particular, the user interface manager 206 can receive information from a notification manager 234 of the content enhancement application 210 indicating a need to provide a user interface with a notification related to the content enhancement application 210.

Moreover, the user interface manager 206 can generate, provide, activate, deactivate, alternate between, modify, and/or otherwise control the presentation of multiple user interfaces corresponding to one or more applications executed on the client device 202. More specifically, the user interface manager 206 can generate, provide, activate, deactivate, alternate between, modify, and or otherwise control the presentation of multiple user interfaces for various functions of the content enhancement application 210, the digital content application 212, the communication application 214, and/or other applications. For example, the user interface manager 206 can provide a user interface related to the communication application 214 and, upon user input indicating a desire to utilize a content enhancement, the user interface manager 206 can switch to presenting a user interface associated with the content enhancement application 210.

As briefly mentioned above, and as illustrated in FIG. 2, the client device 202 may also include a user input detector 208. In one or more embodiments, the user input detector 208 can detect, identify, monitor, receive, process, capture, and/or record various types of user input. In some examples, the user input detector 208 may be configured to detect one or more user interactions with respect to a user interface. As referred to herein, a “user interaction” refers to conduct performed by a user (or a lack of conduct performed by a user) to control the function of a computing device. “User input,” as used herein, refers to input data generated in response to a user interaction.

The user input detector 208 can operate in conjunction with any number of user input devices or computer devices (in isolation or in combination), including personal computers, laptops, smartphones, smart watches, tablets, touchscreen devices, televisions, personal digital assistants, mouse devices, keyboards, track pads, or stylus devices. The user input detector 208 can detect and identify various types of user interactions with user input devices, such as select events, drag events, scroll-wheel events, and so forth. For example, in the event the client device 204 includes a touch screen, the user input detector 208 can detect one or more touch gestures (e.g., swipe gestures, tap gestures, pinch gestures, or reverse pinch gestures) from a user that forms a user interaction.

Furthermore, the user input detector 208 can detect or identify user input in any form. For example, the user input detector 208 can detect a user interaction with respect to a variety of user interface elements, such as selection of a graphical button, a drag event within a graphical object, or a particular touch gesture directed to one or more graphical objects or graphical elements of a user interface. Similarly, the user input detector 208 can detect user input directly from one or more user input devices.

The user input detector 208 can communicate with, and thus detect user input with respect to, a variety of programs, applications, plug-ins, operating systems, user interfaces, or other implementations in software or hardware. For example, the user input detector can recognize user input provided in conjunction with the communication application 214 indicating a desire to compose an electronic message with a content enhancement, recognize user input provided in conjunction with the content enhancement application 210 to select and apply a content enhancement to a digital content item, recognize user input provided in conjunction with the digital content application 212 in selecting a digital content item, and other user input provided in conjunction with other applications.

Furthermore, as illustrated in FIG. 2, and as briefly discussed above, the client device 202 can include a content enhancement application 210. The content enhancement application 210 can include a content manager 228, an enhancement selection information identifier 230, an enhancement manager 232, and a notification manager 234. As described more fully below, the content enhancement application 210 is an application that can identify, provide, modify, and/or apply at least one content enhancement to one or more digital content items.

As mentioned, the content enhancement application 210 may include a content manager 228. The content manager 228 can capture, receive, access, provide, read, record, delete, or modify one or more digital content items. In particular, the content manager 228 can access a digital content item to use in conjunction with one or more content enhancements.

In one or more embodiments, for example, the content manager 228 can utilize one or more devices associated with the client device 202 to capture one or more digital content items. For instance, the content manager 228 can utilize a camera that is part of client device 202 and capture a digital photo to use in conjunction with one or more content enhancements. Similarly, the content manager 228 can capture a video via a video recording device or capture audio via a microphone. The content manager 228 can access any available devices to capture a digital content item for use in conjunction with the content enhancement application 210. Capturing a digital content item can also include communicating with the device storage manager 216 to store the digital content item.

In addition to capturing a digital content item, the content manager 228 can also access existing digital content items from a variety of sources. In particular, the content manager 228 can access digital content items from the device storage manager 216 (e.g., the content item data 246), from a server (e.g., server device 204), from a social network, from cloud-based storage, from another device, from the Internet, or from any other source that can maintain digital content items. In one or more embodiments, the content manager 228 can access digital content items from other applications. For example, the content manager 228 can access a digital content item received via the communication application 214. Similarly, the content manager 228 can access a digital content item captured via the digital content application 212, such as a “camera roll.”

The content manager 228 can also assist in selection of a digital content item for use in conjunction with a content enhancement. The content manager 228 can assist in selecting a digital content item based on a number of possible factors, including but not limited to, user input, content enhancement features, or contextual information (e.g., time, date, or location). For example, in one or more embodiments, the content manager 228 can present a plurality of digital content items and detect user input indicating selection of a particular digital content item. In some embodiments, the content manager 228 can present only recently captured digital content items for selection by a user. Similarly, in other embodiments, the content manager 228 can identify one or more digital content items based on features of a content enhancement selected by the user (e.g., provide a series of video digital content items that are the same duration as a video content enhancement selected by the user).

As described, the content manager 228 can capture, receive, access, and provide digital content items, but it can also perform these functions at various stages of operation of the communication system 200. For example, in one or more embodiments the content manager 228 can capture (or access, receive, or provide) a digital content item to the user via the client device 202 before the user selects a content enhancement. In other embodiments, the user can select a content enhancement before the content manager 228 captures (or accesses, receives, or provides) a digital content item.

For instance, in one or more embodiments, the user can first select one or more content enhancements (e.g. an image of a hat and glasses), and the content enhancement application 210 can cause a display screen to present the one or more content enhancements simultaneously with a presentation of a live camera feed as the user prepares to capture a digital content item (e.g., showing the hat and glasses as an overlay on the live camera feed as a user prepares to capture a digital photo of a person's face). Upon capturing the digital content item, the one or more content enhancements are applied to the digital content item. Thus, a user can customize a digital content item with a selected content enhancement upon capturing the digital content item.

The content manager 228 can also modify previously captured digital content items. In particular, and with regard to images, for example, the content manager 228 can adjust image qualities (e.g., brightness, color, quality, etc.), re-size, stretch, distort, rotate, flip, or otherwise modify an image. Similarly, with regard to audio, the content manager 228 can adjust audio qualities (e.g., pitch, tone, range, volume, etc.), shorten, lengthen, distort, speed up, slow down, or otherwise modify the audio. With regard to video, GIFs, and other digital content items, the content manager 228 can adjust various other qualities depending on the particular type of digital content item.

In addition to the content manager 228, and as illustrated in FIG. 2, the content enhancement application 210 may also include the enhancement selection information identifier (“information identifier”) 230. In one or more embodiments, the information identifier 230 can process, gather, collect, identify, obtain, retrieve, and store enhancement selection information. As used herein, “enhancement selection information” refers to any information that can be used to determine a content enhancement to suggest to a user.

In particular, enhancement selection information can relate to a user's interest in receiving a content enhancement generally or the user's interest in receiving a content enhancement of a particular type, style, format, or feature. For example, enhancement selection information can include features of a digital content item, characteristics of a user, information from a social graph, information regarding (or from) a client device, information regarding (or from) applications installed or running on a client device, information regarding events, general contextual information (e.g., time, date, location, weather, etc.), or other information. Specifically, enhancement selection information can include an item represented in a digital content item (e.g., a picture of a recognizable monument), the location of a digital content item (e.g., location metadata in a photo), demographic information regarding a user (e.g., gender and age), a user's purchase history (e.g., purchased tickets to a particular location), a user's actions on a social network (e.g., “liking” a particular product or event), type of device (e.g., particular brand of tablet), an event planned on the user's calendar (e.g., attending a concert), location of a device (e.g., device located at a sporting venue), the general date and time (e.g., Halloween night), or other information. The enhancement selection information can be used to identify content enhancements to present to a user.

The information identifier 230 can obtain enhancement selection information from a variety of sources. In particular, the information identifier 230 can obtain information from the client device 202, the server device 204, or other external data source. For example, the information identifier 230 can obtain enhancement selection information from characteristics or features of a digital content item, a content enhancement use history, the social graph 224, the Internet, the server storage manager 226 (e.g., the local user profile data 252), an application running on the client device 202, user input, contextual information, metadata, a location device or service, or other source.

As mentioned, the information identifier 230 can collect enhancement selection information from one or more characteristics or features of a digital content item. In particular, the information identifier 230 can analyze the time, date, location, size, length, audio qualities, image qualities, topics, content, metadata or other features of a digital content item to obtain content selection information. Similarly, the information identifier 230 can utilize digital recognition technology, such as item recognition, facial recognition or voice recognition technology, to identify and collect enhancement selection information from digital content items. For example, the information identifier 230 can identify content in a digital photo, such as a type of animal, a particular individual, a part of an item or individual (e.g., a head, eyes, neck, legs, etc.), a location, a place of interest (e.g., monument), an event, and/or other item represented in a digital content item. Similarly, the information identifier 230 can recognize UPC codes, QR codes, brands, slogans, or logos to identify enhancement selection information related to particular products, companies, or causes.

Moreover, as briefly mentioned, the information identifier 230 can obtain enhancement selection information from a variety of applications. In particular, the information identifier 230 can obtain enhancement selection information from a calendaring application, a web browsing application, a social media application, the communication application 214, the digital content application 212, a shopping application, or any other application. For example, the information identifier 230 can collect information indicating that an individual may have an interest in a particular content enhancement related to sports based on a calendar item in a calendaring application showing that the user is attending a sporting event, based on a web-browser search related to a sporting event, based on a social media post relating to a sporting event, based on a message received related to a sporting event, based on a photograph taken at a sporting event, and/or based on a purchase of tickets for a sporting event (e.g., upon detecting an email receipt).

In addition to accessing enhancement selection information from other applications, the information identifier 230 can also obtain enhancement selection information from the social graph 224. For example, the information identifier 230 can utilize the social graph 224 to obtain information regarding friends, family, associations, purchases, likes, interests, interactions, posts, events, messages, and other data.

The information identifier 230 can also collect enhancement selection information from other content enhancements utilized as part of the communication system 200. In particular, the information identifier 230 can analyze content enhancements previously received, selected, sent, viewed, ignored, or deleted to obtain enhancement selection information. For example, the information identifier 230 can obtain enhancement selection information from a message received on the client device 202 containing one or more content enhancements. Similarly, the information identifier 230 can obtain enhancement selection information from a content enhancement the user selected to send in an electronic communication. For example, the content enhancement information identifier 230 could determine that a user has repeatedly selected content enhancements related to a particular sport, and determine corresponding enhancement selection information (e.g., that the user has an interest in content enhancements related to the particular sport).

The information identifier 230 can collect any type of enhancement selection information. For example, the information identifier 230 can obtain enhancement selection information related to characteristics of a user, recipient, sender, or other individual. In particular, the information identifier 230 can obtain demographic information related to an individual. In this regard, the information identifier 230 can obtain demographic information from the device storage manager 216 (including local user profile data 252), from the server device 204 (including the server storage manager 226 and the user profile database 258), from user input, or from any other source of demographic information.

Similarly, the information identifier 230 can collect enhancement selection information related to the location of a user or client device 202. The information identifier 230 can obtain this information from a variety of sources, including analysis of the contents of a digital content item (as previously discussed), metadata, a global positioning system, a social media application (or other application), location features of a client device, proximity technologies or any other location source or service.

Furthermore, the information identifier 230 can obtain enhancement selection information from other general contextual information stored on the client device 202, the server device 204, the Internet, or any other source. For example, the information identifier 230 can obtain contextual information such as the time and date, whether the client device 202 is online, or other contextual information associated with the user and/or client device 202.

The information identifier 230 can perform its functions continuously, periodically, or in response to a triggering event. For example, the information identifier 230 can obtain enhancement selection information based on a user interaction, execution of an application, or some other triggering event. In particular, the information identifier 230 can collect enhancement selection information based on a user interaction indicating that a user seeks to utilize a content enhancement or seeks to capture a digital content item. By way of example, the information identifier 230 can seek to obtain enhancement selection information when a user captures, via user interaction with the client device 202, a digital photo using the client device 202. Similarly, the enhancement information selection identifier 230 can obtain enhancement selection information whenever the enhancement selection application 210 is running on the client device 202. In other embodiments, the enhancement information selection identifier 230 can collect enhancement selection information at all times.

The information identifier 230 can also store enhancement selection information. In particular, the information identifier 230 can store enhancement selection information to the device storage manager 216 (e.g., the enhancement selection information 250), to the server device 204 (e.g., the server storage manager 226), or to some other information storage location. Similarly, the information identifier 230 can retrieve previously stored enhancement selection information.

As previously mentioned, and as illustrated in FIG. 2, the client device 202 may also include the enhancement manager 232. The enhancement manager 232 can suggest, present, select, create, generate, modify, remove, and/or apply one or more content enhancements with respect to one or more digital content items. In one or more embodiments, for instance, the enhancement manager 232 can suggest context specific content enhancements based on content enhancement information. In one or more embodiments, the enhancement manager 232 can also analyze, process, manipulate, or utilize enhancement selection information to select one or more context specific content enhancements to suggest to a user.

In particular, the enhancement manager 232 can select a content enhancement based on enhancement selection information related to the features of a digital content item. For example, the enhancement manager 232 can select a content enhancement based on the time, date, location, size, duration, size, audio qualities, image qualities, subjects, topics, contents or other features of a digital content item (in isolation or in combination). For example, the enhancement manager 232 can select an audio content enhancement based on the duration of a digital content item (e.g., so that the audio content enhancement has a duration that is less than or equal to the duration of the digital content item). Similarly, for example, based on the fact that a user captured a digital content item in Los Angeles on Christmas Eve, the enhancement manager 232 can present a series of digital content items related to that specific time and location (e.g., a symbol of Santa in shorts).

Similarly, the enhancement manager 232 can select one or more content enhancement items based on the objects represented in a digital content item. For example, the enhancement manager 232 can select a content enhancement based on a digital content item containing a representation of a particular individual (e.g., picture of a user's friend), item (e.g., a house), product (e.g., a particular brand of drink), location (e.g., hometown), animal (e.g., a cat), event (e.g., sound of a “Happy Birthday” song), monument (e.g., video of Eiffel Tower in the background), or other feature. For example, the enhancement manager 232 can select a content enhancement related to cats (e.g., an image of a cat or an audio file of a cat) if a picture contains a representation of a cat. Similarly, if a picture contains an image of a particular friend, the enhancement manager 232 can select a content enhancement related to the particular friend. Moreover, if a photograph is a picture at a concert, the enhancement manager 232 can select a content enhancement related to the concert or performer.

Moreover, the enhancement manager 232 can select a content enhancement based on a digital content item containing a representation of a product, company, or cause. In particular, the enhancement manager 232 can select a content enhancement based on a digital content item containing a representation of a brand (e.g., photo of a trademark/logo), a product (e.g., photo of a shoe), a brick and mortar store (e.g., photo outside of a store), a representative UPC code, a representative QR code, a slogan (e.g., audio of a company slogan) or other representation of a product, company, or cause. For example, if a user takes a photograph of a popular brand, the enhancement manager 232 can provide a content enhancement related to the company associated with the brand.

Furthermore, the enhancement manager 232 can select a content enhancement based on features of other content enhancements. In particular, the enhancement manager 232 can select a content enhancement based on user selection of a content enhancement related to a particular topic, item, event, product, or other feature. For example, if a user selects a content enhancement wishing someone a happy birthday, the enhancement manager 232 can select one or more additional content enhancements related to a birthday event.

The enhancement manager 232 can also select a content enhancement based on features of an electronic message. In particular, the enhancement manager 232 can select a content enhancement based on images, text, topics, items, content enhancements, or other features of an electronic message. For example, if a user receives an electronic message containing text referring to an upcoming graduation from college, the enhancement manager 232 can select one or more content enhancements related to graduation or the college.

In addition, the enhancement manager 232 can also select a content enhancement based on one or more features of an event. In particular, the enhancement manager 232 can select a content enhancement based on the time, location, participants, purposes, or other features of an event. For example, if a user has entered a calendar item indicating an upcoming vacation to Washington, D.C., the enhancement manager 232 can select a related content enhancement (e.g., content enhancements with various monuments from the area, content enhancements related to vacations, or content enhancements related to political leaders).

Similarly, the enhancement manager 232 can select a content enhancement based on information obtained from a social graph. In particular, the enhancement manager 232 can select a content enhancement based on node information 254 and/or edge information 256. For example, if a user has indicated an interest in a particular movie (e.g., “liked” a node associated with the particular movie), the enhancement manager 232 can provide one or more content enhancements related to the movie (e.g., a picture of an actor in the movie or an audio clip from the movie). The enhancement manager 232 can select a content enhancement based on any node information, edge information, or combination thereof.

Similar to (or in combination with) social graph information, the enhancement manager 232 can select a content enhancement based one or more characteristics of a user (including characteristics of a sender of a message, a recipient of a message, a user of the client device 202, or some other user). In particular, the enhancement manager 232 can select a content enhancement based on demographic information (e.g., age, gender, etc.), purchases, user searches, web-page visits, residence, or other user characteristics. For example, the enhancement manager 232 can provide a content enhancement that includes an advertisement (or a link to an advertisement) for a popular store, based on a determination that the user matches a demographic profile associated with the store and that the user is located near a store location.

As discussed, the enhancement manager 232 can also select one or more content enhancements based on location of a user or client device. For example, if a client device is located at or near a sports venue, the enhancement manager 232 can select a content enhancement related to the sports venue, sports played at the venue, teams playing at the venue, or other characteristics of the location. Similarly, if a client device is located near a particular store or company, the enhancement manager 232 can select one or more content enhancements related to the store or company.

Moreover, the enhancement manager 232 can select one or more content enhancements based on the time and/or date associated with a client device. For example, in December, the enhancement manager 232 can select one or more content enhancements related to Christmas, Hanukah, New Years, or other holidays. Similarly, in the early morning, the enhancement manager 232 can select one or more content enhancements related to the time of day (e.g., symbol of a coffee cup or image of a sunrise).

The enhancement manager 232 can utilize a variety of methods to determine content enhancements to suggest to a user. For example, in one or more embodiments the enhancement manager 232 employs an algorithm that analyzes content enhancement selection information, weights and ranks the content enhancement selection information, searches for content enhancements, and/or weights and ranks the content enhancements resulting from the search. For instance, the enhancement manager 232 can utilize an algorithm that identifies topics of interest from the enhancement selection information, weights the topics of interest, ranks the content topics of interest, and searches for one or more content enhancements related to topics of interest.

In particular, in one or more embodiments, the enhancement manager 232 defines topics associated with particular content enhancements and compares the topics associated with particular content enhancements with the topics of interest identified from the content enhancement information. Similarly, in one or more embodiments, the enhancement manager 232 utilizes an algorithm to weight and rank the resulting content enhancements based on the strength of association between the content enhancements and the digital content items and/or the topics of interest. In such an embodiment, for an example, a content enhancement with numerous overlapping topics of interest of significant weight can rank higher than a content enhancement with a single overlapping topic of interest of little weight.

For example, the enhancement manager 232 can receive information from the information identifier 230 indicating that the user has an upcoming anniversary on January 15, that the user recently expressed interest in a basketball team on a social media service, and that the current date is December 14. The enhancement manager 232 can employ an algorithm to identify potential topics of interest to the user (e.g., marriage, anniversary celebration, basketball, the basketball team, Christmas, New Years, etc.), weight and rank the topics of interest (e.g., because January 1 is more than two weeks away, weight New Years less heavily than Christmas but more heavily than the anniversary on January 15), and search for content enhancements related to the enhancement selection information based on the weighted and ranked topics (e.g., an image of a Santa hat on a basketball, an image of a party hat, an image of a wedding ring). Further, in some embodiments, the enhancement manager 232 can employ an algorithm to rank the resulting content enhancements (e.g., rank the image of a Santa hat on a basketball the highest because it relates to both Christmas and basketball) and then suggest the content enhancements based on the resulting ranking.

In other embodiments, the enhancement manager 232 can also utilize an algorithm based on analytics and user history to identify content enhancements to suggest from enhancement selection information. For example, the enhancement manager 232 can determine that other users associated with particular enhancement selection information had previously selected a certain content enhancement. Based on this information, upon identifying enhancement selection information similar to the particular enhancement selection information associated with the other users, the enhancement manager 232 can suggest the certain content enhancement.

In other embodiments, the enhancement manager 232 can determine a strength of association between enhancement selection information, a topic of interest and/or a particular content enhancement. The strength of association can provide a basis for weighting and ultimately ranking enhancement selection information, topics of interest, and/or content enhancements. For example, if all of the individuals belonging to a certain social media group have utilized a particular content enhancement; upon determining that a user also belongs to the certain social media group, the enhancement manager 232 can weight that enhancement selection information heavily in determining what content enhancements to suggest.

As mentioned previously, aside from selecting content enhancements, the enhancement manager 232 can also create content enhancements (e.g., allow a user to create a content enhancement). For example, the enhancement manager 232 can create content enhancements from all or part of one or more digital content items, based on a user modifying existing content enhancements, or from some other source or method.

For example, the enhancement manager 232 can allow a user to create a content enhancement from an audio, video, GIF, image, or other file. Specifically, if a user has captured an audio file via the content device 202, the enhancement manager 232 can utilize the audio file as a content enhancement. Similarly, if a user has taken a photograph that portrays the user, the enhancement manager 232 can create a content enhancement from the entire photo, from the portion portraying the user, from the portion portraying the user's face, or from some other portion of the photo. In addition, if a user takes a video of a person, the enhancement manager can create a content enhancement from the entire video, from the video images representing the person, or some other portion of the video. The enhancement manager 232 can identify a portion of the digital content item to convert to a content enhancement based on user input, based on digital recognition technologies, or some other computer technique.

As discussed, in one or more embodiments, the enhancement manager 232 can create a video content enhancement. In particular, the enhancement manager 232 can capture modifications to an existing content enhancement over time to create a video content enhancement. For example, the enhancement manager 232 can capture modifications as a user re-sizes, moves, flips, rotates, and/or otherwise modifies a content enhancement over time to create a video content enhancement.

More specifically, the enhancement manager 232 can capture modifications of a content enhancement in relation to a digital content item. For instance, the enhancement manager 232 can capture modifications to a content enhancement as an overlay to a video digital content item playing over time. For example, the enhancement manager 232 can capture a user moving a content enhancement (e.g., an image) so that it follows over a person portrayed in a video. This permits a user to create a content enhancement specific to a particular digital content item.

In other embodiments, the enhancement manager 232 can provide a content enhancement that interacts with one or more features of a video, without user input. For example, the enhancement manager 232 can provide a content enhancement that modifies itself based upon features of the video digital content item. Specifically, the enhancement manager 232 can provide a content enhancement that identifies a particular object in a video (e.g., a person's head), and then modifies the content enhancement based on the features of the particular object in the video (e.g., provides a hat image that moves, re-sizes, and rotates based on the location, size, and rotation of the person's head).

In addition to creating content enhancements, the enhancement manager 232 can also present one or more content enhancements to a user operating the client device 202 via a user interface. In particular, the enhancement manager 232 can present, via a user interface, one or more context specific content enhancements. In some embodiments, the enhancement manager 232 presents content enhancements selected without the use of content enhancement information. For example, the enhancement manager 232 can have a standard directory of content enhancements that the enhancement manager 232 presents to a user via a user interface.

In one or more embodiments, the enhancement manager 232 can also provide the user with one or more templates. In particular, the enhancement manager 232 can provide a template containing one or more pre-populated content enhancements. The enhancement manager 232 can provide a template based on any user interaction indicating that the user seeks to send an electronic message containing a content enhancement. The enhancement manager 232 can populate the content enhancements based on enhancement selection information or other available information. For example, if a user seeks to send a message containing a content enhancement to a particular friend, the enhancement manager 232 can pre-populate the electronic message based on content enhancements utilized in communications with the particular friend in the past.

Furthermore, in other implementations, the enhancement manager 232 can provide feedback to the user regarding how a digital content item compares to one or more content enhancements. In particular, the enhancement manager 232 can provide feedback comparing a variety of features of a content enhancement and a digital content item. For example, if a user has selected an audio digital content enhancement (e.g., the sound of a scream), the enhancement manager 232 can display the length of the content enhancement as compared to the time of a digital content item the user has captured (or is capturing).

The enhancement manager 232 can provide feedback at various points of operation of the communication system 200. For instance, the content manager 228 can provide feedback comparing features of a digital content item and features of a content enhancement during selection (or capture) of a digital content item, during selection (or creation) of a content enhancement, or some other time. By way of example, if a user has captured an audio digital content item, the content manager 228 can display the amplitude of audio signals from the audio digital content item over time in relation to the amplitude of audio signals of one or more audio content enhancements over time. This particular implementation, for example, may aid the user in selecting a content enhancement that best matches the digital content item.

The content manager 228 can provide similar feedback with regard to other digital content items and content enhancements. If a user has selected a video content enhancement, the digital content item can display the video content enhancement while a user captures a video digital content item. Similarly, if a user has selected video digital content item, the content manager 228 can display the duration of the digital content item compared to the duration of the content enhancement. This may aid the user in selecting a content enhancement that best matches the digital content item.

The enhancement manager 232 can also modify content enhancements. In particular, enhancement manager 232 can modify content enhancements for presentation in conjunction with a digital content item. For example, the enhancement manager 232 can re-size, stretch, rotate, flip, adjust audio qualities (e.g., pitch, tone, range, volume, etc.), adjust image qualities (e.g., brightness, color, quality, etc.), shorten, lengthen, distort, speed up, slow down, or otherwise modify a content enhancement. The enhancement manager 232 can modify a content enhancement based on user input, enhancement selection information, or on some other basis.

In one or more embodiments, the enhancement manager 232 can modify the content enhancement based on the features of a digital content item. For example, the enhancement manager 232 can modify the content enhancement based on an item represented within the digital content item. More specifically, if a user wishes to utilize a photo digital content item portraying a person, and the user selects a content enhancement portraying a set of eyeglasses, the enhancement manager 232 can re-size, rotate, move, and otherwise modify the content enhancement portraying a set of eyeglasses based on the size, rotation, location, and other features of the person's eyes in the photograph. Similarly, if a user wishes to utilize an audio digital content item, the enhancement manager 232 can modify an audio content enhancement based on the audio characteristics of the digital content item (e.g., so that the volume of the audio digital content item and the audio content enhancement will roughly match). Similarly, as discussed, the enhancement manager 232 can modify a content enhancement to interact with one or more items portrayed in a video digital content item.

In a similar manner, the enhancement manager 232 can delete, hide, or remove a portion of a content enhancement so that it appears to interact with one or more items within a digital content item. In particular, the enhancement manager 232 can delete a portion of a content enhancement so that it appears to rest on, hide behind, or otherwise interact with a digital content item. For example, if an image digital content item contains a picture of a wall, the enhancement manager 232 can delete a portion of the content enhancement so that it appears that a portion of the content enhancement is hiding behind the wall, climbing over the wall, and/or sitting on the wall. Similarly, if an image digital content item contains a picture of a person, the enhancement manager 232 can delete a portion of the content enhancement so that it appears that a portion of the content enhancement is located behind the person.

The enhancement manager 232 can perform its functions in any order and at any time during operation of the communication system 200. For example, the enhancement manager 232 can present, select, modify, create, or otherwise manage content enhancements at a variety of points during operation of the communication system 200. For example, the enhancement manager 232 can present content enhancements upon execution of the content enhancement application 210, upon a user capturing a digital content item, upon receiving an electronic communication, upon initiating the digital content application 212, upon composing a reply to an electronic communication containing one or more content enhancements, upon a user interaction indicating a desire to add a content enhancement (e.g., selection of a button indicating a desire to add a content enhancement), or upon some other event (or upon more than one of the foregoing events).

More specifically, the enhancement manager 232 can present content enhancements upon execution of the content enhancement application 210, present content enhancements again upon a user capturing a digital content item, and present content enhancements again upon a user selecting a button indicating a desire to add more content enhancements. Similarly, the enhancement manager 232 can create a video content enhancement before the user captures or selects a digital content item, while the client device 202 captures a digital content item, after a user captures or selects a digital content item, while the client device 202 plays a video digital content item, or at some other time.

In addition, the enhancement manager 232 can select content enhancements based on content enhancement information at a variety of points during operation of the communication system 200. For example, the enhancement manager 232 can select content enhancements based on content enhancement information before the enhancement manager 232 presents content enhancements to a user, at all times when the content enhancement application 210 is running, when the client device 202 captures a digital content item, when the client device 202 receives an electronic communication, when a user selects a content enhancement, when the client device 202 begins to run the content enhancement application 210, when a user composes a reply to an electronic communication containing one or more content enhancements, when the user provides a user interaction indicating a desire to add a content enhancement, or at some other time.

Aside from creating, modifying, suggesting, and selecting content enhancements, the enhancement manager 232 can also store one or more content enhancements. In particular, the enhancement manager 232 can store one or more content enhancements to the device storage manager 216 as enhancement data 248. For example, upon creating a new content enhancement based on user input, the enhancement manager 232 can store the new content enhancement.

The enhancement manager 232 can also retrieve one or more content enhancements. In particular, the enhancement manager 232 can retrieve one or more content enhancements from the device storage manager 216 and the enhancement data 248. The enhancement manager 232 can also retrieve one or more content enhancements from the server device 204, such as through the content enhancement director 220, the server storage manager 226, or through some other storage medium.

In addition to the enhancement manager 232, and as shown in FIG. 2, the content enhancement application 210 may also include the notification manager 234. In one or more embodiments, for example, the notification manager 234 can provide notifications related to the content enhancement application 210. In particular, the notification manager 234 can present notifications to help ensure that a user of the client device 202 is aware of the features available through the communication system 200, and in particular, is aware of the ability to apply content enhancements to digital content items. The notification manager 234 can, for example, communicate with the user interface manager 206 to present notifications via a user interface. The notification manager 234 can provide a variety of notifications, including icons, dialogue boxes, banners, buttons, pop-ups, or other elements.

The notification manager 234 can present notifications based upon a variety of factors, including, utilization of a digital content application; utilization of a communication application; and/or passage of time. For example, the notification manager 234 can present a notification when the client device 202 runs the digital content application 212, when the client device 202 captures a digital content item using the digital content application 212, when a user reviews or accesses a digital content item using the digital content application 212, or upon other events.

Similarly, the notification manager 234 can present a notification when the client device 202 runs the communication application 214, when the client device 202 receives an electronic communication through the communication application 214, when the client device 202 receives an electronic communication containing content enhancements through the communication application 214, when the communication application sends an electronic communication through the communication application 214, when the client device 202 sends an electronic communication containing a digital content item, or upon other events.

Moreover, if a user fails to utilize a content enhancement or the content enhancement application 210 for a specified period, the notification manager 234 can present a notification. For example, if a user sends electronic communications for a week without utilizing a content enhancement, the notification manager 234 can present a notification.

In one or more embodiments, the notification manager 234 can adjust the frequency of notifications so as not to annoy or overburden a user. For example, the notification manager 234 can delay providing a notification until a user has captured five digital content items and failed to utilize the content enhancement application 232 for a period of one week. Similarly, the notification manager 234 can delay providing a notification until a user has sent five digital content items via the communication application 214. The notification manager 234 can adjust the frequency of triggering events or the types of triggering events that prompt the notification manager 234 to provide a notification.

Regardless of frequency, the notification manager 234 can present notifications through the content enhancement application 210 or other components of the client device 202. In particular, the notification manager 234 can present notifications through other applications, including the digital content application 212 and the communication application 214. For example, if a user captures an image using the digital content application 212, the notification manager 234 can present a notification through the digital content application 212, such as an icon indicating that the user can add a content enhancement to the image. Similarly, if a user composes an electronic message containing a digital content item through the communication application 214, the notification manager 234 can present a dialogue box indicating that the user can add a content enhancement to the digital content item.

The notification manager 234 can generate notifications that provide a user with one or more options. In particular, the notification manager 234 can provide notifications to a user with options to execute another application, capture a digital content item, utilize a content enhancement, compose a message containing a content enhancement, install an application, invite others to utilize or install an application, or some other option.

The notification manager 234 can provide various options based on a variety of factors. For example, the notification manager 234 can provide options based on the presence or absence of an application on the client device 202 or another client device, the capabilities of the client device 202 or another device (e.g., whether the device can capture a particular digital content item), the status of the client device 202 (e.g., online, offline), the status of a user with regard to the network system 217 (e.g., logged in, logged out, member, non-member, etc.) or some other factor. For example, based on a determination that the client device 202 has not installed the content enhancement application 210, the notification manager 234 can provide an option to install the content enhancement application 210 on the client device 202.

As illustrated in FIG. 2, the client device 202 may also include the digital content application 212. As shown, the digital content application 212 can include a content capturer 236 and a content handler 238. The digital content application 212 can manage digital content for the communication system 200. As discussed, the digital content application 212 can capture, access, review, modify, or store digital content items. Although shown, and referred to herein, as a single application, the digital content application 212 can constitute multiple applications. For example, one digital content application 212 can capture audio while another digital content application 212 can capture photos or video.

As briefly mentioned above, the digital content application 212 may include the content capturer 236. In one or more embodiments, the content capturer 236 can capture digital content items for use in the communication system 200. The content capturer 236 can include a separate device (e.g., an external camera that communicates with the digital content application 212) or a part of the client device 202 (e.g., a camera built into a mobile phone). The content capturer 236 can also comprise multiple devices (e.g., a camera, a video recorder, and an audio recorder).

Moreover, as shown in FIG. 2, the digital content application 212 may also include the content handler 238. The content handler 238 can access, present, send, receive, modify, record, or delete digital content items. In particular, the content handler 238 can access, send, and receive digital content from other components of the communication system 200. For example, the content handler 238 can access a digital content item captured by the content capturer 236 and send the digital content item to the device storage manager 216 as content item data 246 for the device storage manager 216 to maintain. Likewise, the content handler 238 can provide digital content to the content enhancement application 210.

Moreover, as discussed above, the functions performed by the content manager 228 can also be performed by the digital content application 212 and its components. For example, in some embodiments, the content manager 228 can capture a digital content item for use in conjunction with a content enhancement. In other embodiments, however, the communication system 200 can detect selection of a content enhancement through the content enhancement application 210, run the digital content application 212 to capture or access a digital content item, and, upon completion of capturing or accessing a digital content item, run the content enhancement application 210. The digital content application 212 can also initiate use of the content enhancement application 210. In particular, as discussed above, the notification manger 234 can provide a notification via the digital content application 212 regarding the capabilities of the content enhancement application.

Furthermore, as shown in FIG. 2, the client device 202 can also include the communication application 214. As illustrated, the communication application 214 can include a message handler 242 and a communication notification manager 244. The communication application 214 can send or receive electronic communications, provide or present notifications, and communicate with other components of the communication system 200.

As mentioned, the communication application 214 may include message handler 242, as illustrated in FIG. 2. Generally, the message handler 242 manages electronic communication for the communication application 214. More particularly, the message handler 242 can coordinate with one or more components of the client device 202 to facilitate the sending and receiving of electronic communications.

For example, the message handler 242 can interact with the user interface manager 206 and the user input detector 208 to coordinate formatting and packaging input data, as well as other content, in an electronic communication to send via the communication application 214. The message handler 242 can send messages via one or more communication channels using an appropriate communication protocol. Likewise, the message handler 242 can receive and process electronic communications the client device 202 receives from other devices, including messages received through the server device 204.

Similarly, the message handler 242 can interact with the content enhancement application 210 (or other applications) to receive content enhancements and/or digital content items to include in an electronic communication. For instance, the message handler 242 can receive one or more digital content items with one or more content enhancements from the content enhancement application 210 for use in sending an electronic communication. Similarly, the message handler 242 can send information to the content enhancement application 210, such as data indicating that the message handler 242 has received an electronic communication that contains one or more content enhancements.

In addition to providing communication functions within the communication application 214, the message handler 242 can provide access to message data used by the communication application 214. For example, the message handler 242 can access data that represents a list of contacts, or one or more groups of contacts, to include as recipients to a message. To illustrate, the message handler 242 can obtain and provide data representing a contact list to the user interface manager 206 to allow the user to search and browse a contact list, and ultimately select an individual contact, multiple contacts, or group of contacts to include as recipients of a message. In one or more embodiments, the network system 217 (e.g., a social networking system) can maintain remote contact list data (e.g., a “friends list”), and the message handler 242 can access, or request to receive, the contact list data from the network system 217 for use within the messaging application 242.

The message handler 242 can also retrieve or store data as necessary to perform its functions. For example, the communication application 214 can retrieve or maintain data from the device storage manager 216, including content item data 246, content enhancement data, 248, or local user profile data 252. Similarly, the message handler 242 can store or retrieve data from the server device 204.

As shown in FIG. 2 the communication application 214 can also include the communication notification manager 244. The communication notification manager 244 provides, receives, presents, and/or manages notifications for the communication application 214. For instance, in some embodiments, the communication application 214 can utilize the communication notification manager 244 to provide notifications regarding the communication system 200 where the content enhancement application 210 is not installed on the client device 202.

The communication notification manager 244 can provide various notifications and/or options. For example, in one or more embodiments, the communication notification manager 244 can provide any of the notifications previously described in relation to the notification manager 234 of the content enhancement application 210 (e.g., where the content enhancement application 210 is not installed). For example, the communication notification manager 244 can provide a notification to a user via a user interface reminding the user regarding the features of the content enhancement application 210. Similarly, the communication notification manager 244 can provide a notification comprising an option to compose an electronic message containing content enhancements or other options as previously discussed.

The communication notification manager 244 can provide notifications based upon a variety of factors or triggering events. For instance, the communication notification manager 244 can provide notifications upon sending or receiving one or more electronic communications, sending or receiving one or more electronic communications containing a digital content item, sending or receiving one or more electronic communications containing a content enhancement, or any user interaction indicating a desire to utilize a content enhancement. By way of example, before sending an electronic communication containing a digital content item, the communication notification manager 244 can provide a notification via the user interface including an option to add a content enhancement.

The communication notification manager 244 can also provide various notifications depending on the status of the client device 202, the status of an application, or the availability an application. For example, if the user has not installed or downloaded the content enhancement application 210 on the client device 202, the communication notification manager 244 can provide a notification including an option to install the content enhancement application 210. More specifically, if the communication application 214 receives an electronic communication containing a content enhancement or a digital content item, and the content enhancement application 210 is not installed on the client device 202, the communication notification manager 244 can provide a notification via a user interface that provides an option to install the content enhancement application 210.

If the user selects an option to install the content enhancement application 210, the client device 202 can communicate with the server device 204 and the installer 222 to download all data, files, plug-ins, libraries, or other information necessary to install the content enhancement application 210. Upon installation of the content enhancement application 210, the client device 202 can execute the content enhancement application 210. Thus, the communication system 200 can provide notifications regarding the availability of features provided by the content enhancement application 210 and options to utilize the features provided by the content enhancement application 210, even though the content enhancement application 210 has not yet been installed on the client device 202.

The communication notification manager 244 can communicate with the server device 204 and the content enhancement director 220 to receive information necessary to provide notifications in the absence of a content enhancement application 210. For example, the content enhancement director 220 (or some other component) can provide information regarding the format, content, frequency, and timing of notifications if the content enhancement application 210 has not been installed. Where the content enhancement application 210 has been installed, the notification manager 234, the content enhancement director 220, or some other component can provide information regarding the format, content, frequency, timing, or other factors related to notifications.

As shown in FIG. 2, and as discussed previously, the device storage manager 216 can contain content item data 246, enhancement data 248, enhancement selection information 250, and local user profile data 252. The device storage manager 216 can store data received from or provide data to any component of the client device 202 or the server device 204, or some other information or storage source.

As discussed previously, the communication system 200 can also include server device 204. As illustrated in FIG. 2, in one or more embodiments the server device 204 can provide a network system 217. For instance, the network system 217 can be any of one or more services that provide, in whole or in part, communication capabilities between two or more users. In one or more embodiments, for example, the network system 217 is a social-networking system (e.g., Facebook™). Alternatively, the network system 217 can be another type of communication system, communication network, communication service, or any other type of system that uses user accounts.

Furthermore, as shown in FIG. 2, the server device 204 can also include the communication manager 240. The communication manager 240 can facilitate receiving and sending data. In particular, the communication manager 240 can facilitate sending and receiving electronic communications. Specifically, the communication manager 240 can receive and send electronic communications between the client device 202 and another client device, for example between computing device 102 operated by user 110 and computing device 104 operated by user 112. For example, the communication manager 240 can package content to be included in an electronic communication and format the electronic communication in any necessary form that is able to be sent through one or more communication channels and using an appropriate communication protocol. In particular, the communication manager 240 can receive and send electronic communications containing one or more digital content items and one or more content enhancements.

In addition, as illustrated in FIG. 2, the server device 204 can also include the content enhancement director 220. The content enhancement director 220 can facilitate identifying, selecting, providing, storing, retrieving, and directing content enhancements within the communication system 200. The content enhancement director 220 can also direct notifications regarding content enhancements or the content enhancement application 210.

The content enhancement director 220 can provide content enhancements for the content enhancement application 210. For instance, the content enhancement director 220 can provide a set of content enhancements to the client device 202 (e.g., the enhancement data 248 or the content enhancement application 210). For example, the content enhancement director 220 can access the enhancement database 264 and provide to the client device 202 (e.g., the device storage manager 216, the content enhancement data 246, or the content enhancement application 210) all or some of the content enhancements stored within the enhancement database 264. Likewise, the content enhancement director 220 can update some or all of the content enhancements on the client device 202 as new or additional content enhancements become available.

Similarly, the content enhancement director 220 can select one or more content enhancements to provide to the client device 202. The content enhancement director 220 can select content enhancements based on information received from the client device 202, information from the social graph 224, information from the server storage manager 226 (e.g., the user profile database 258), client input, or some other source. For instance, the content enhancement director 220 can receive enhancement selection information from the content enhancement application 210 or the device storage manager 216 and select one or more content enhancements to provide to the client device 202. In particular, the information identifier 230 may obtain enhancement selection information and provide that information to the content enhancement director 220 so that the content enhancement director 220 can obtain new content enhancements from the enhancement database 264, and send the new content enhancements to the client device 202.

The content enhancement director 220 can also provide enhancement selection information (or other information) to the client device 202 (e.g., the content enhancement application 210, information identifier 230, the device storage manager 216, and enhancement selection information 250). For example, the content enhancement director 220 can obtain information from the social graph 224 and provide the pertinent information to the information identifier 230 to facilitate the enhancement manager 232 in selecting a context specific content enhancement.

The content enhancement director 220 can also provide content enhancements sponsored by a third-party, such as an advertisement for a product, company, or cause. Such sponsored content enhancements may be associated with one or more recommendation policies, where the third-party sponsor prefers to provide the content enhancements to certain targeted individuals. The content enhancement director 220 can provide the content enhancements together with policies that define when to present the sponsored content enhancements to a user operating the client device 202. For example, the content enhancement director 220 can provide a content enhancement containing a brand name for a children's amusement park together with a policy that the content enhancement should only be selected for presentation to users that have children.

The content enhancement director 220 can access and provide advertising content enhancements comprising various images, video recordings, audio files, GIFs, links, text, URLs, or other electronic information. The content enhancement director 220 can obtain information regarding advertisements from the server storage manager 226, including advertising content 260, or from some other source.

As illustrated in FIG. 2, the server device 204 may also include the installer 222. The installer 222 can provide all applications, plug-ins, updates, libraries, executable files, or other electronic information to install necessary components of the communication system 200. In particular, the installer 222 can provide data necessary to install the content enhancement application 210. In some embodiments, the installer 222 can be included on the client device 202. For instance, the communication application 214 could include the installer 222, such that the communication application 214 could install the content enhancement application 210 directly from information on the client device 202 (e.g., without a connection to the server).

As further illustrated in FIG. 2, in the case of the network system 217 being a social-networking system, the network system 217 may include a social graph 224 for representing and analyzing a plurality of users and concepts. As shown in FIG. 2, the social graph 224 can include node information 254 that stores information comprising nodes for users, nodes for concepts, and/or nodes for items. In addition, the social graph 224 can include edge information 256 comprising relationships between nodes and/or actions occurring within the social-networking system. Further detail regarding social-networking systems, social graphs, edges, and nodes is presented below.

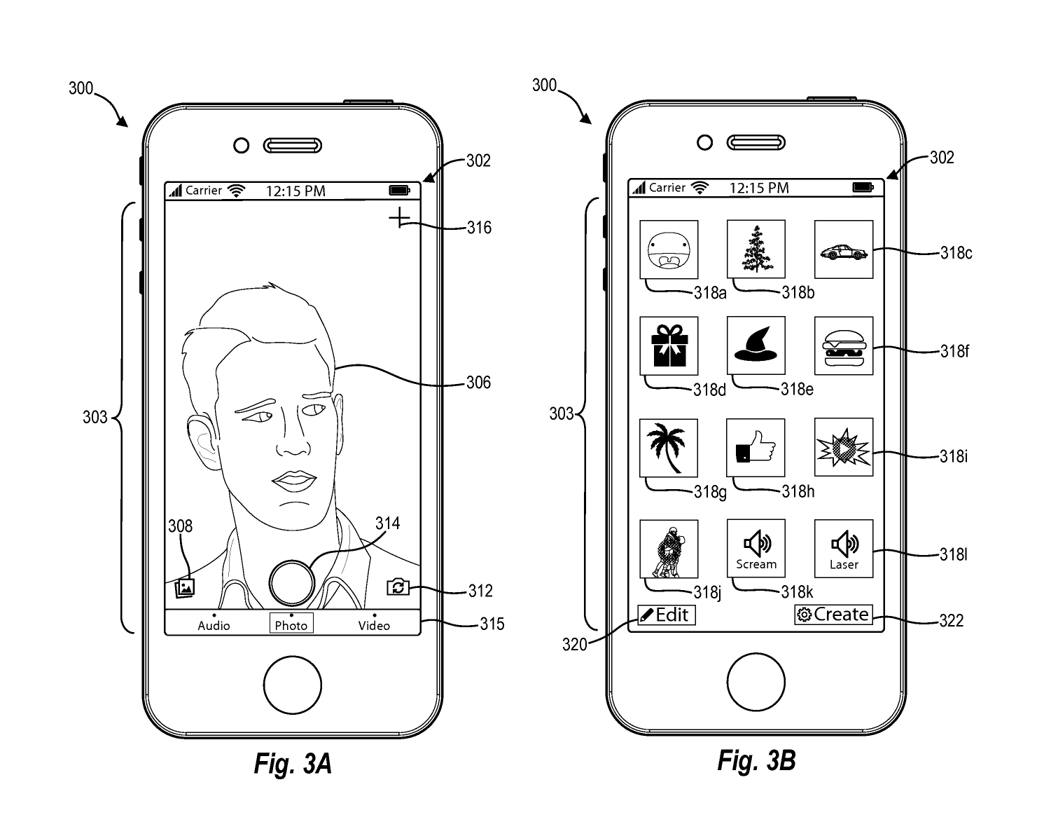

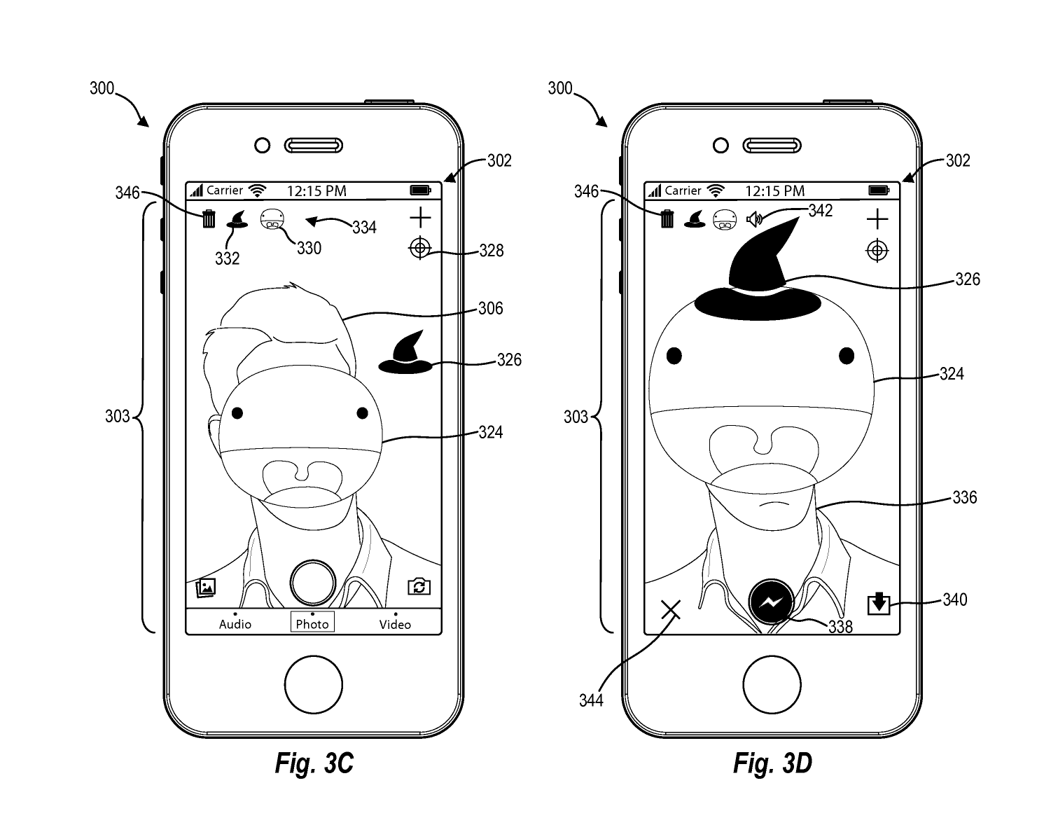

Referring now to FIGS. 3A-3D, additional detail will be provided with respect to particular embodiments of the communication system 200 and presentation of the communication system 200 through one or more graphical user interfaces. For example, FIG. 3A illustrates a computing device 300 (e.g., a mobile device such as a smartphone) that may implement one or more components of the communication system 200. As illustrated in FIG. 3A, the computing device 300 may include and/or be associated with a touch screen 302. Additionally or alternatively, computing device 300 may include any other suitable input device (e.g., a keypad, one or more input buttons, etc.). As shown, the communication system 200 can present, via the touch screen 302, a user interface 303.

The user interface 303 may provide one or more embodiments of the user interface discussed above with regard to the content enhancement application 210. As illustrated in FIG. 3A, in one or more embodiments, the user interface 303 can include a variety of components, elements, or icons, such as a camera selection icon 312 (e.g., to select from a front or a back camera associated with the client device), image 306, content selection element 308, capture element 314, and enhancement addition element 316.

As FIG. 3A illustrates, and as just mentioned, user interface 303 can display an image, such as image 306. The image 306 can constitute a single still image, an image representing a sequence of images (i.e., a video sequence), or an image feed reflecting images received by a camera device that the camera device can capture. The image 306 can assist the user in capturing a digital content item or allow a user to capture an image in relation to one or more content enhancements.

As shown, the user interface 303 also includes content selection element 308. Upon user interaction with the content selection element 308, the communication system 200 can enable a user to select a previously captured digital content item. The communication system 200 can utilize the content enhancement application 210 or the digital content application 212 (e.g., “camera” application, “camera roll” application, “photo” application, “microphone” application, or “recording” application) to present digital content items.

FIG. 3A also illustrates capture element 314 within user interface 303. Upon user interaction with the capture element 314, the communication system 200 captures a digital content item. Content ribbon 315 adjusts the type of digital content item the communication system 200 will capture. As shown in FIG. 3A, the content ribbon 315 is set to “photo”; thus, upon user interaction with the capture element 314, the communication system 200 will capture a digital photo using a camera device associated with the computing device 300. A user can adjust the content ribbon 315 (e.g., by applying a swipe gesture on the ribbon) to another type of digital content item (e.g., audio, video, etc.).

In addition to the capture element 314, FIG. 3A also illustrates enhancement addition element 316. Upon selection of the enhancement addition element 316, the communication system 200 can suggest one or more content enhancements to the user via the computing device 300. In particular, FIG. 3B illustrates the computing device 300 presenting, via user interface 303, a plurality of representations 318a-318l. In the illustrated embodiment, each of the representations, 318a-318l, signifies a single content enhancement; in other embodiments, representations 318-318l can provide representations signifying multiple content enhancements. For example, in some embodiments the communication system 200 presents representations signifying multiple content enhancements belonging to a related group (e.g., holiday content enhancements, enhancements featuring a particular character, etc.).

As discussed in detail above, the communication system 200 can suggest or present one or more content enhancements based on content enhancement selection information. FIG. 3B illustrates user interface 303 presenting content enhancement representations, 318a-318l, some of which the communication system 200 may suggest based on content enhancement selection information. In particular, in FIG. 3B, the communication system 200 can provide representation 318b (i.e., image of a tree) based on social graph information (i.e., user indicating interest in an environmental conservation group through a social media service). Similarly, the communication system 200 can provide representation 318c (i.e., image of a car) based on recent purchase information (i.e., user recently purchasing a vehicle); representation 318d (i.e., image of a birthday present) based on information contained in an electronic communication (i.e., a message containing the words “Happy Birthday”); representation 318e (i.e., image of a witch hat) based on general contextual information (i.e., a current date in the month of October); representation 318f (i.e., image of a hamburger) based on location information (i.e., user operating the computing device 300 at a hamburger restaurant); and representation 318g (i.e., image of a palm tree) based on an upcoming event (i.e., a calendar item indicating a trip to Hawaii).

As illustrated in FIG. 3B, the communication system 200 can also suggest or present one or more content enhancements that are not based on content enhancement selection information. Indeed, in one or more embodiments, the communication system 200 can maintain a standard directory of content enhancements. For example, the communication system 200 can provide representations 318a and 318h as standard content enhancement suggestions without consideration of content enhancement selection information.

The communication system 200 can remove or replace content enhancements from a standard directory of content enhancements based on content enhancement selection information, including user interaction with content enhancements. For example, with regard to FIG. 3B, the communication system 200 can detect that a user has not selected the content enhancement associated with representation 318a for a period of time, and based on that information, can remove the content enhancement 318a from a standard directory of content enhancements such that the communication system 200 no longer presents representation 318a to the user.

Furthermore, as illustrated in FIG. 3B, the communication system 200 can provide a variety of different types of content enhancements. For example, representations 318a-318h signify image content enhancement, representations 318i, 318j signify video content enhancements, and representations 318k, 318l signify audio content enhancements.

Moreover, as discussed previously, the communication system 200 can also modify one or more content enhancements. FIG. 3B illustrates one mode of modifying content enhancements, via edit element 320 displayed within user interface 303. Upon user interaction with edict element 320, the communication system 200 enables a user to modify features (e.g., color) of one or more content enhancements (as described above). The communication system 200 can provide other means via the user interface 303 for modifying content enhancements, as discussed below.

Furthermore, as mentioned, in one or more embodiments the communication system 200 can enable a user to create one or more content enhancements. For example, as shown in FIG. 3B, a user can interact with create element 322 displayed as part of user interface 303. Upon user interaction with the create element 322, the communication system 200 provides a user interface, via the computing device 300, to create one or more content enhancements. In particular, the communication system 200 can provide a user interface for capturing an audio file, capturing a video, capturing an image, or creating, copying, downloading, or uploading an electronic file that can be utilized as a content enhancement. The communication system 200 can provide a user interface for creating a content enhancement either directly through the content enhancement application 210 or through another application (such as the digital content application 212).

Regardless of how a content enhancement is created, upon selection of a content enhancement by a user, the communication system 200 can provide the content enhancement to the user via the computing device 300. For example, FIG. 3C shows the computing device 300 upon selection of representations 318a and 318e from FIG. 3B. In response, the communication system 200 provides content enhancements 324 and 326 (corresponding to representations 318a and 318e) as part of the user interface 303.

As shown in FIG. 3C, the communication system 200 can display content enhancements 324, 326 in relation to image 306. As discussed, image 306 can be part of an image feed representing images that can be captured by a camera device. Displaying content enhancements in conjunction with an image feed allows a user to capture a digital content item in relation to the content enhancements 324, 326 (e.g., capturing a digital content item such that the content enhancements are located in a certain position in relation to the digital content item). Alternatively, the communication system 200 can display content enhancements 324, 326 in relation to a previously captured digital content item.

As illustrated in FIG. 3C, when displaying content enhancements the communication system 200 can display an enhancement summary area 334. The enhancement summary area 334 displays summary elements 330, 332, representing selected content enhancements 324, 326, respectively. In some embodiments, the enhancement summary area 334 displays only the content enhancement the user has most recently interacted with (e.g., pressed, modified, moved, etc.). In other embodiments, as shown, the enhancement summary area 334 displays all selected content enhancements. Moreover, the communication system 200 can modify presentation (e.g., order) of the content enhancements based on user interaction with the enhancement summary area 334. For example, upon user interaction with element 332, the communication system 200 can display content enhancement 326 on top of content enhancement 324 (as shown in FIG. 3D).

Although FIG. 3C illustrates content enhancement 324 and content enhancement 326 with an initial set of features (e.g., in particular locations, sizes, orientations, etc.), as previously discussed, the communication system 200 can modify the content enhancements. More specifically, in response to a pinch gesture on the touch screen 302 in relation to the content enhancement 324, the communication system 200 can resize content enhancement 324 (i.e., make it larger or smaller). Similarly, in response to a press and drag gesture on the touchscreen 302 in relation to content enhancement 326, the communication system 200 can relocate the content enhancement 324 (i.e., move left, right, up, or down on the user interface 303). In response to a two finger rotate gesture, the communication system 200 can rotate the content enhancement 326.

In one or more embodiments, the communication system 200 can both rotate and resize content enhancements at the same time. For example, in response to a single-finger double-tap event with regard to the content enhancement 324, the communication system 200 can initiate a combined resize and/or rotation modification operation. In particular, after the initial single-finger double-tap event, upon a linear movement (i.e., vertical or horizontal movement of the finger on the touchscreen 302 away from the initial double-tap location), the communication system 200 can resize the content enhancement. Upon a radial movement (i.e., an angular movement around the initial double-tap location), the communication system 200 can rotate the content enhancement. Moreover, upon a combined linear and radial movement (i.e., moving the finger further away from or toward the initial double-tap location and around the initial double-tap location) the communication system 200 can both rotate and resize the content enhancement.

In yet other embodiments, the communication system 200 can flip content enhancements (i.e., rotate the content enhancement 180 degrees around an axis). The communication system 200 can flip content enhancements around a vertical axis, a horizontal axis, or some other axis. In one or more embodiments, the communication system 200 can flip a content enhancement in response to a double-tap event. In other embodiments, the communication system 200 can flip content enhancements in response to a double-tap gesture and a press and drag gesture defining the axis of rotation around which the flip event will occur.

In addition to modifying content enhancements based on user input, the communication system 200 can also modify content enhancements based on one or more features of a digital content item or features of computing device 300. For example, FIG. 3C illustrates target icon 328. Upon user interaction with the target icon 328, the communication system 200 can detect an object (e.g., an object displayed on the user interface 303) and modify a content enhancement in relation to the object. For instance, in response to user selection of the target icon 328, the communication system 200 can modify content enhancement 324 and/or content enhancement 326 based on the image 306 such that the content enhancement 324 covers the head of a person displayed in image 306 and the content enhancement 326 rests on top of the head of the person displayed in image 306 (as shown in FIG. 3D). The communication system 200 can modify individual content enhancements or multiple content enhancements in relation to one or more objects.

With regard to such automatic modifications (i.e., without user input in relation to each modification), the communication system 200 can modify content enhancements statically (e.g., modify content enhancements a single time to fit a single static image) or dynamically (e.g., repeatedly modify content enhancements to fit a sequence of changing images). For example, as illustrated in FIG. 3C, the user has not yet captured a digital content item, and image 306 represents an image feed representing digital images that could be captured by a camera device at any given time. The communication system 200 can actively modify the content enhancements 324, 326 (e.g., the size, location, orientation of the content enhancements) based on the location of objects displayed in image 306 (e.g., modify content enhancement 324 so that it moves to cover the head of the person pictured as the head in image 306 moves).

FIG. 3D illustrates the computing device 300 of FIG. 3C after modification of content enhancements 324, 326, and after capturing a digital content item 336. Although FIG. 3D illustrates the communication system 200 capturing a digital content item after selection of one or more content enhancements it will be recognized that the communication system 200 can capture a digital content item at various times during operation of the communication system 200. For example, the communication system 200 can detect a user interaction with the capture element 314 (and capture a digital content item) before a user has selected a content enhancement, after presenting a content enhancement, before or after user-selection of a content enhancement, before or after modifying a content enhancement, before or after collecting enhancement selection information, before or after capturing a content enhancement, before or after presenting a template, or at any other time.

As just discussed, FIG. 3D shows content enhancements 324, 326 after modification. In particular, the communication system 200 has modified content enhancements 324, 326 based on the features of the captured digital content item 336 by placing content enhancement 324 over the face of the person pictured in the digital content item 336 and placing content enhancement 326 on top of the head of the person pictured in the digital content item 336. In other embodiments the communication system 200 can make the modifications to the content enhancements 324, 326 shown in FIG. 3D based on user input (e.g., pinch gestures, drag gestures, etc.).

As previously mentioned, to reduce the amount of time required to utilize the communication system 200, in one or more embodiments the communication system 200 can provide one or more templates. For example, based on a determination that the date is October 31, the communication system 200 can select, provide, and modify the content enhancements 324, 326, 342 as shown in FIG. 3D without selection of specific content enhancements by a user, modifications by a user, or any other unnecessary user input. In particular, upon selection of a digital content item (or upon running the content enhancement application 210 or some other event) the communication system 200 can provide content enhancements 324, 326 (or other content enhancements related to Halloween) and modify the content enhancements based on digital content item 336. Moreover, the communication system 200 can provide other types of content enhancements, for example, audio content enhancement 342 (corresponding to audio “scream” representation 318d). Thus, templates can reduce the amount of time to utilize the communication system 200 while still providing a variety of customized, unique, enjoyable enhancements to digital content items.

FIG. 3D also illustrates a storage element 340. As discussed previously, the communication system 200 permits storage of digital content items and/or one or more content enhancements. Upon user interaction with storage element 340, the communication system 200 stores a digital content item with one or more content enhancements on the computing device 300.

Furthermore, the communication system 200 can delete digital content items and/or content enhancements. As shown in FIG. 3D, the communication system 200 can delete digital content item 336 upon user interaction with delete element 344. Moreover, the communication system 200 can delete content enhancements 324, 326, 342 through user interaction with trash icon 346 (e.g., a user can select and drag content enhancement 342 to trash icon 346).

Moreover, as illustrated by the embodiment shown in FIG. 3D, upon capturing a digital content item, the communication system 200 changes capture element 314 to messaging element 338. Upon user interaction with messaging element 338, the communication system 200 can create an electronic message containing a digital content item and one or more content enhancements. In one or more embodiments, upon user interaction with messaging element 338, the communication system 200 utilizes the communication application 214, and sends one or more electronic messages containing the digital content item with the content enhancements to one or more recipients through the communication application 214.

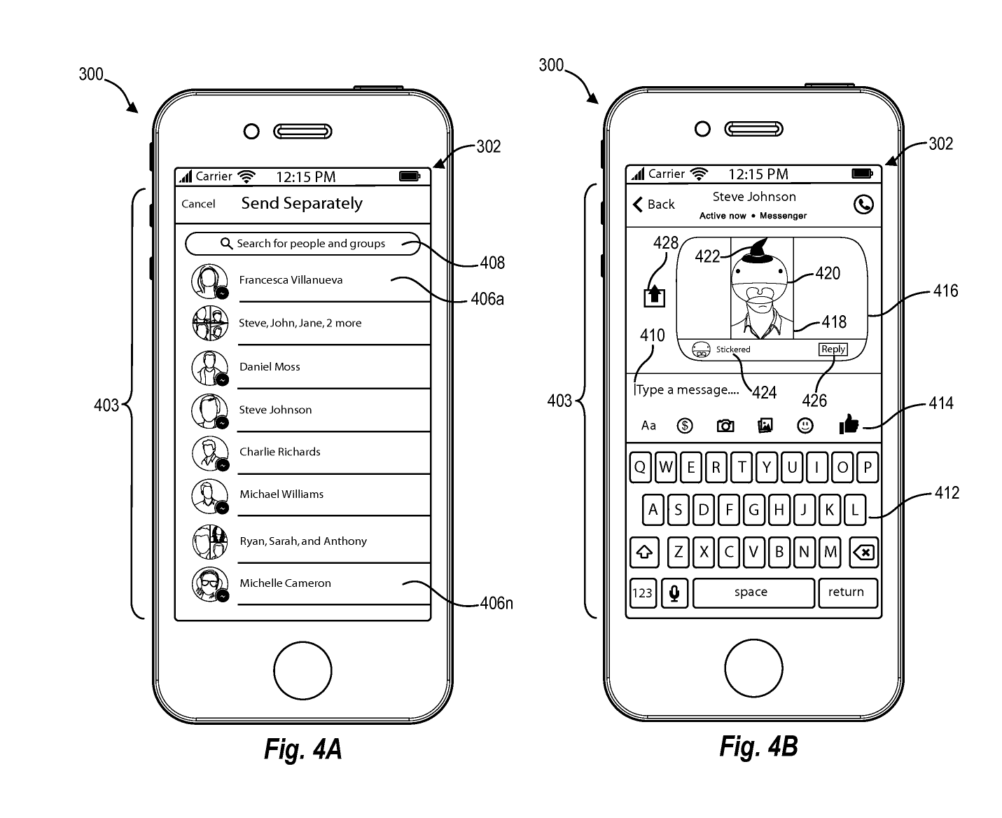

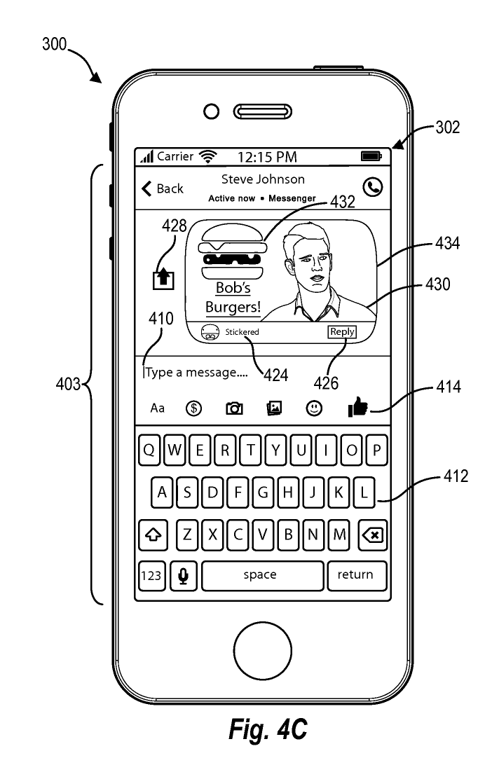

For example, FIG. 4A illustrates a user interface with a list of contacts displayed in accordance with one or more embodiments. In one or more embodiments, upon user interaction with messaging element 338, the communication system 200 displays user interface 403 on display screen 302, as part of the computing device 300. In particular, user interface 403 can implement one or more embodiments of a user interface discussed previously with regard to the communication application 214.

As shown in FIG. 4A, the user interface 403 can display a list of individual contacts, 406a-406n, and a search element 408. The contacts, 406a-406n, can include contacts from a variety of sources, including contacts from e-mail services or applications, contacts stored on the computing device 300, contacts from one or more social media applications or services, or some other contacts (in isolation or in combination). As shown, the list of contacts, 406a-406n, can include individual contacts (e.g., “Daniel Moss”) or groups of contacts (e.g., “Steve, John, Jane, 2 more”).

Regardless of how a list of contacts is presented, upon selection of one or more contacts (or one or more groups of contacts), in one or more embodiments the communication system 200 provides a user interface to assist in preparing, displaying, and sending an electronic communication containing an enhanced digital content item. In particular, FIG. 4B illustrates the computing device 300 displaying user interface 403. The user interface 403 facilitates the display of electronic communications sent by a user of the computing device 400 and/or received from one or more users. As illustrated in FIG. 4B, the user interface 403 can display a communication thread between the user of device 400 and another user (i.e., “Steve Johnson”).

FIG. 4B illustrates an electronic message 416 containing digital content item 418 (e.g., corresponding to digital content item 336) with content enhancements 422, 420 (e.g., corresponding to content enhancements 326, 324). Although not represented visually, the electronic message 416 can also include an audio content enhancement (e.g., corresponding to content enhancement 342, i.e., an audio “scream”). As illustrate in FIG. 4B, the communication system 200 can send electronic message 416 containing digital content item 418 and multiple content enhancements (e.g., 420, 422), to one or more recipients (e.g., “Steve Johnson”).

The user interface 403 can include an input bar 410 (capable of presenting and composing electronic messages prior to sending), an input element 412 (capable of selecting, adding, removing, or altering characters with regard to the input bar 406), and additional communication options 414 (e.g., emoticons). As described above, one or more embodiments of the communication system 200 can enable a user to send electronic communications with enhanced digital content items without unnecessarily adding to (or cluttering) components 406-410 of user interface 403.

For example, upon sending an electronic communication, the communication system 200 can provide enhancement icon 424 with the electronic communication. Upon user interaction with the enhancement icon 424, the communication system 200 can enable utilization of one or more content enhancements in conjunction with a digital content item. In particular, the communication system 200 can install and/or execute the content enhancement application 210.

The communication system 200 can provide the enhancement icon 424 (or some other notification) when sending electronic communications containing one or more content enhancements, such as electronic communication 416. In some embodiments, (as described above) the communication system 200 can provide the enhancement icon 424 when sending or receiving electronic communications that do not contain content enhancements (e.g., after a certain amount of time has passed without utilizing the content enhancement application 210).

Although previously described in terms of sending an electronic communication, FIG. 4B also illustrates a communication user interface for receiving an electronic message in accordance with one or more embodiments. Thus, upon receiving an electronic communication, the communication system 200 can present the electronic communication 416 containing the digital content item 418 and content enhancements (e.g., 420, 422) to one or more recipient. For example, the communication system 200 can present any type of content enhancements to one or more recipients upon receipt of an electronic communication containing content enhancements. For example, in some embodiments, the communication system 200 can play enhanced audio or video digital content items upon a recipient receiving or viewing an electronic message.

The communication system 200 can also provide to one or more recipients notifications regarding the capabilities of the communication system 200. For example, as shown in FIG. 4B, when a recipient receives electronic communication 416 containing content enhancements 420, 422, the communication system 200 can provide reply icon 426.

For instance, the communication system 200 can provide reply icon 426 to a recipient in conjunction with, or as an alternative to, enhancement icon 424. Upon selection of the reply icon 426 (or enhancement icon 424), the communication system 200 can enable utilization of one or more content enhancements, including any notifications or options previously described. For example, upon selection of the reply icon 426, the communication system 200 can provide user interface 303 (as illustrated in FIG. 3A-3D) to compose an electronic communication containing a digital content item and one or more content enhancements.

Although FIG. 4B illustrates a particular electronic message with a particular digital content item and content enhancement, it will be appreciated that the communication system 200 can send or receive a variety of electronic communications containing a variety of digital content items and/or content enhancements. For example, FIG. 4C illustrates the computing device 300, displaying communication user interface 403 with an electronic communication 434 containing a digital content item 430 with an advertising content enhancement 432. As illustrated, advertising content enhancement 432 contains advertising content for “Bob's Burgers,” including a brand image (i.e., a picture of a hamburger) and text containing a hyperlink or other selectable link (i.e., “Bob's Burgers!”). The hyperlink in the advertising content enhancement 432 can contain a URL or other electronic information necessary to enable a user or recipient to open a website (e.g., a company website, a website for ordering product, an advertising website, a website containing coupons or deals, etc.).

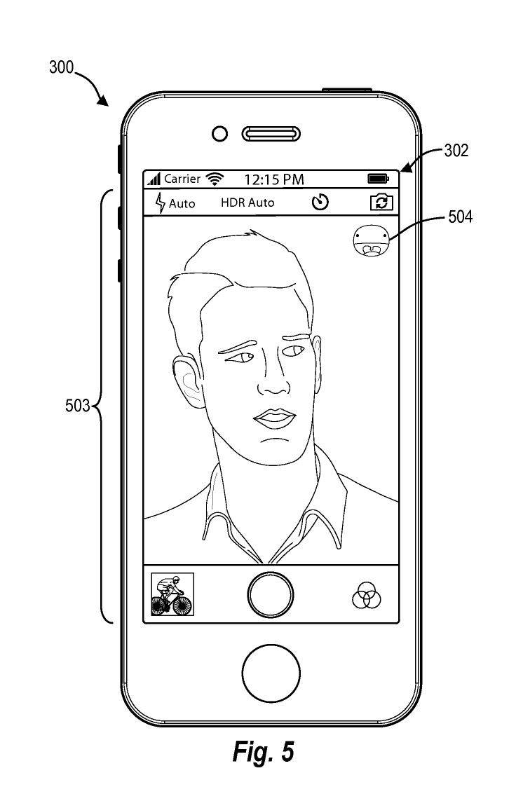

As discussed previously, the communication system 200 can also operate in conjunction with digital content application 212. FIG. 5 illustrates one embodiment of a user interface 503 displayed on touchscreen 302 of computing device 300. The user interface 503 can implement, for example, the user interface described previously with regard to digital content application 212. The communication system 200 can utilize the user interface 503 to capture, select, or modify one or more digital content items or content enhancements.

As illustrated in FIG. 5, in one or more embodiments, the communication system 200 displays the enhancement icon 504 within the camera user interface 503. For example, (and as discussed previously) when a user captures a digital content item through digital content application 212, the communication system 200 can display the enhancement icon 504 to remind the user regarding content enhancement features of the communication system 200. Upon user interaction with the content enhancement icon 504, the communication system 200 can provide a variety of options and/or enable the user to utilize the content enhancement features described herein. For example, upon a user interacting with the content enhancement icon 504, the communication system 200 can import a digital content item captured with the content application 212 into the content enhancement application 210 to allow a user to apply one or more content enhancements.

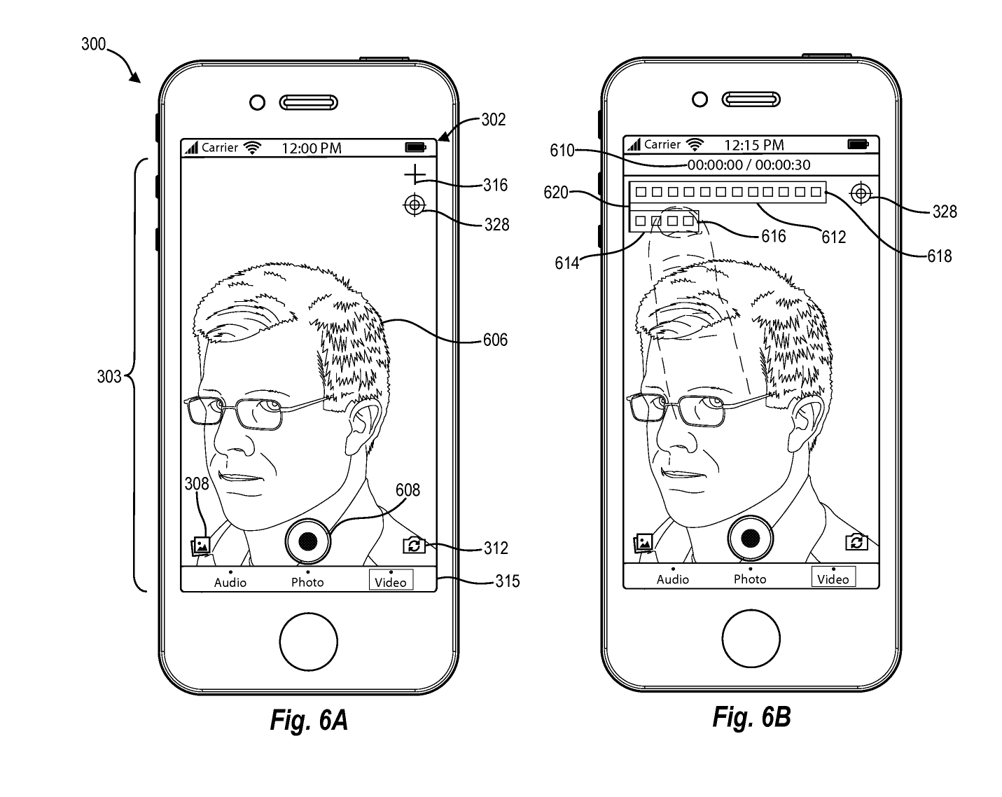

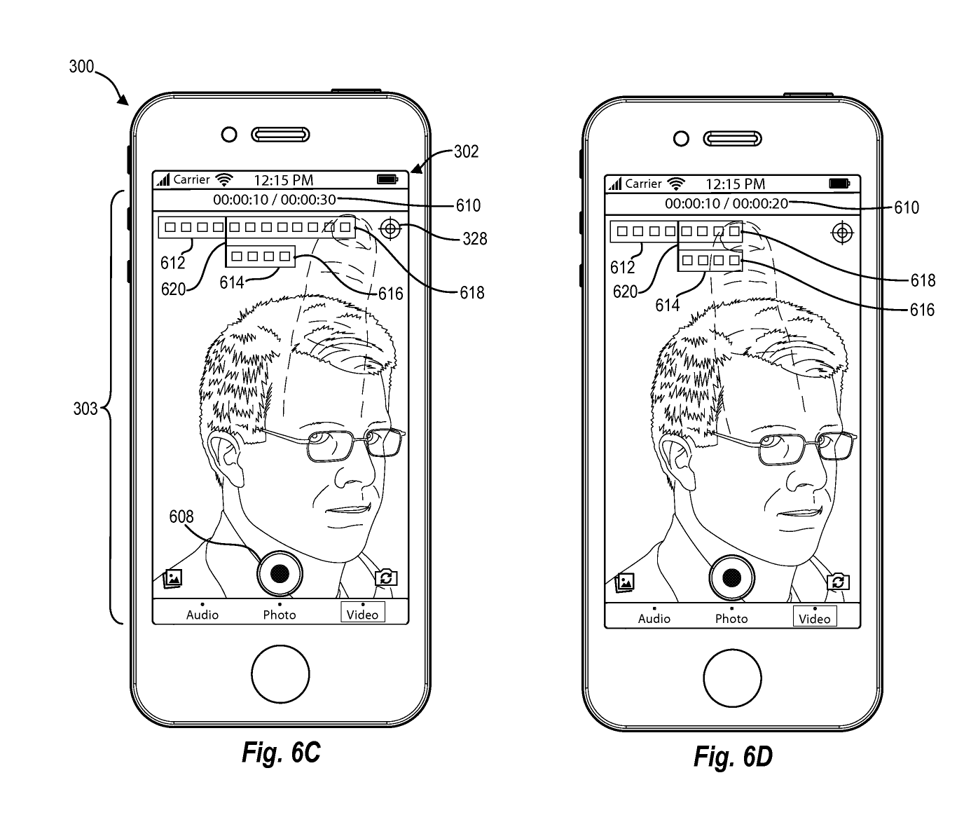

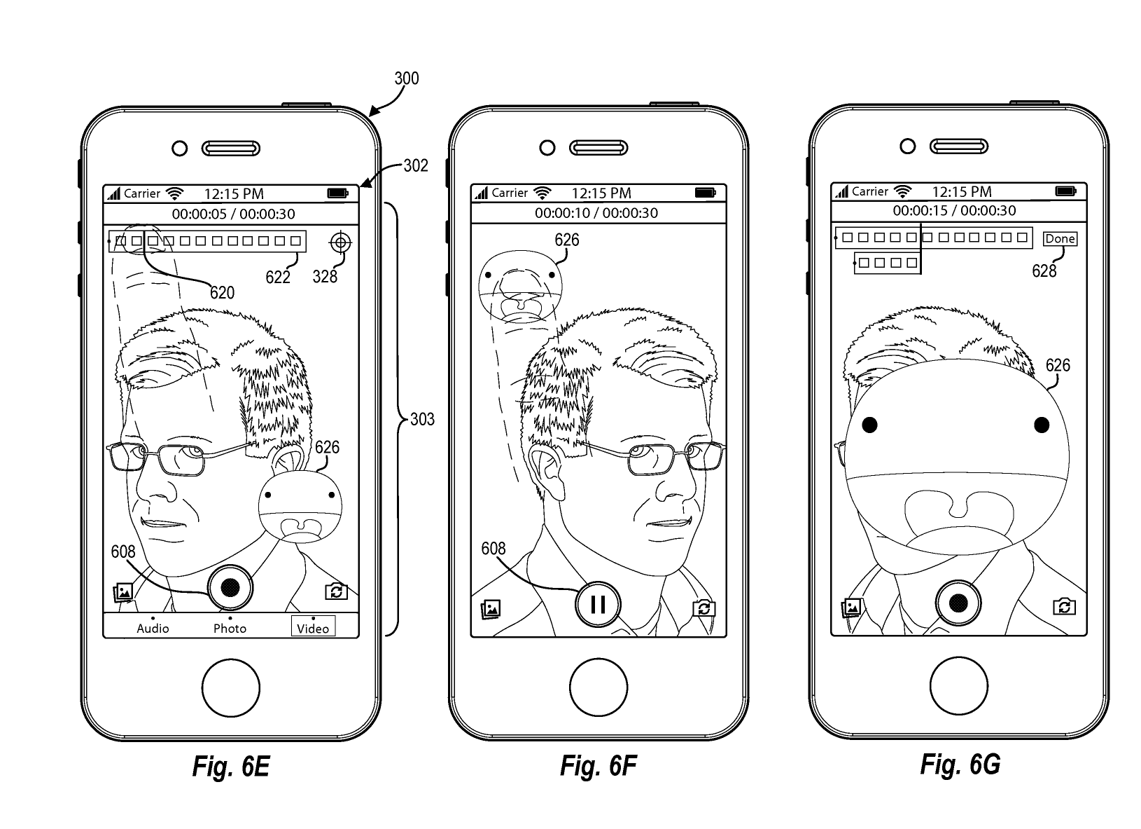

Referring now to FIGS. 6A-6G, additional details will be provided with regard to embodiments of the communication system 200 providing a user interface for capturing or modifying video digital content items and video content enhancements. FIGS. 6A-6G illustrate the computing device 300 displaying user interface 303 on touchscreen 302, where a user has selected the video option in the content ribbon 315. The user interface 303 in FIG. 6A contains a capture element 608 for capturing a video digital content item. Moreover, the user interface 303 displays video image 606.

FIG. 6B illustrates a user interface according to one embodiment for presenting a video digital content item and/or a video content enhancement. For example, in one embodiment, upon selecting a video content enhancement (e.g., content enhancement 318i) and a video digital content item, the communication system 200 can present the user interface 303 shown in FIG. 6B. The user interface 303 includes timing element 610, which displays the current time corresponding to the current playing position together with the total duration of the video digital content item and/or content enhancements. As displayed, the current time corresponding to the current playing position is 00:00:00 out of a total duration of 00:00:30.

As discussed previously, the communication system 200 can provide feedback regarding a digital content item and one or more content enhancements. FIG. 6B illustrates an example of such feedback. In particular, the user interface 303 includes digital content timeline 612 and content enhancement timeline 614, which illustrate the relative duration, start positions, and end positions of a digital content item and content enhancement. As discussed, the communication system 200 can enable a user to modify a video content enhancement in relation to a digital content item. For example, FIG. 6B illustrates one example embodiment of how a user can modify a video content enhancement so that the video content enhancement will play at a different time relative to the digital content item. In particular, FIG. 6C illustrates the results of a press and drag event relative to the content enhancement timeline 614 such that the content enhancement begins and stops at a different time in relation to the digital content item. Specifically, as illustrated in FIG. 6C, a user moves the content enhancement timeline 614 in relation to the digital content timeline 612 so that the content enhancement will begin at 00:10:00 of the digital content item.

Similarly, the communication system 200 can modify the duration of the content enhancement or digital content item. For example, FIG. 6A-6C illustrate trim elements 616, 618. Upon user interaction with trim elements 616, 618, the communication system 200 can remove or expand portions of the video digital content item and/or video content enhancement. Thus, as shown in FIG. 6D, a user can select and drag trim element 618 to remove a portion of the video digital content item. In particular, the user has trimmed ten seconds of the digital content item such that the total duration of the digital content item is 00:00:20, as displayed in the timing element 610 of FIG. 6D. By displaying both the digital content item timeline 612 and the content enhancement timeline 614, the communication system 200 allows a user to modify digital content items and content enhancements in relation to each other.

In addition to modifying video digital content items and video content enhancements, the communication system 200 can also capture video content enhancements. FIGS. 6E-6F illustrate a user interface in one embodiment of the communication system 200 for capturing a video content enhancement in relation to a video digital content item.

FIG. 6E illustrates a digital content item timeline 622 reflecting a video digital content item and the navigation bar 620. The communication system 200 enables a user to navigate to a position on the digital content timeline 622 (corresponding to a particular portion of the video digital content item) using a navigation bar 620. For example, as illustrated in FIG. 6E, a user can utilize the navigation bar 620 to identify a starting location to capture a content enhancement in relation to a digital content item. In particular, the user has navigated to 00:00:05 within the digital content item, as reflected in the timeline element 610.

Upon detecting a user interaction with the capture element 608, the communication system 200 can begin capturing a content enhancement. In one or more embodiments, the communication system 200 can capture a video content enhancement by capturing modifications to an existing content enhancement over time. For example, as shown in FIG. 6F a user can select content enhancement 626, modify the location of content enhancement 626 over time, and capture the modifications as a video content enhancement. In addition to moving the content enhancement 626, the user can resize the content enhancement 626 (as shown in FIG. 6G) or modify the content enhancement 626 in other ways.

In some embodiments, the communication system 200 captures the modifications to the content enhancement 626 while playing the digital content item over time. In particular, as shown in FIG. 6F, the viewing area 303 displays the digital content item at 00:00:10 while also capturing modifications to the content enhancement 626. Such an embodiment permits a user to modify the content enhancement 626 in relation to the digital content item (e.g., move the content enhancement over time in relation to movement of objects displayed within the video digital content item over time).

In one or more embodiments, the user can pause and/or resume capturing a content enhancement. As shown in FIG. 6F, the communication system can change the capture element 608 to display a pause image. Upon user interaction with the capture element 608 when displaying a pause image, the communication system can pause a capturing operation. The communication system 200 can resume capturing based on further user interaction with the capture element 608.

The communication system 200 can also detect when a user has completed capturing a content enhancement. For example, as shown in FIG. 6G, the communication system 200 can provide a completion element 628. Upon user interaction with the completion element 628, the communication system 200 can store the enhanced video digital content (or proceed to some other operation of the communication system 200, such as sending the enhanced video digital content).

In alternative embodiments, rather than capture user-directed modifications, the communication system 200 can modify the content enhancement over time without user input. For example, based on user interaction with the target icon 328, the communication system 200 can modify the content enhancement in relation to the digital content item without further user input (e.g., move, resize, relocate, reorient, the content enhancement based on an object displayed over time in a digital content item). The communication system 200 can capture such modifications over a period of time to create a video digital content item.

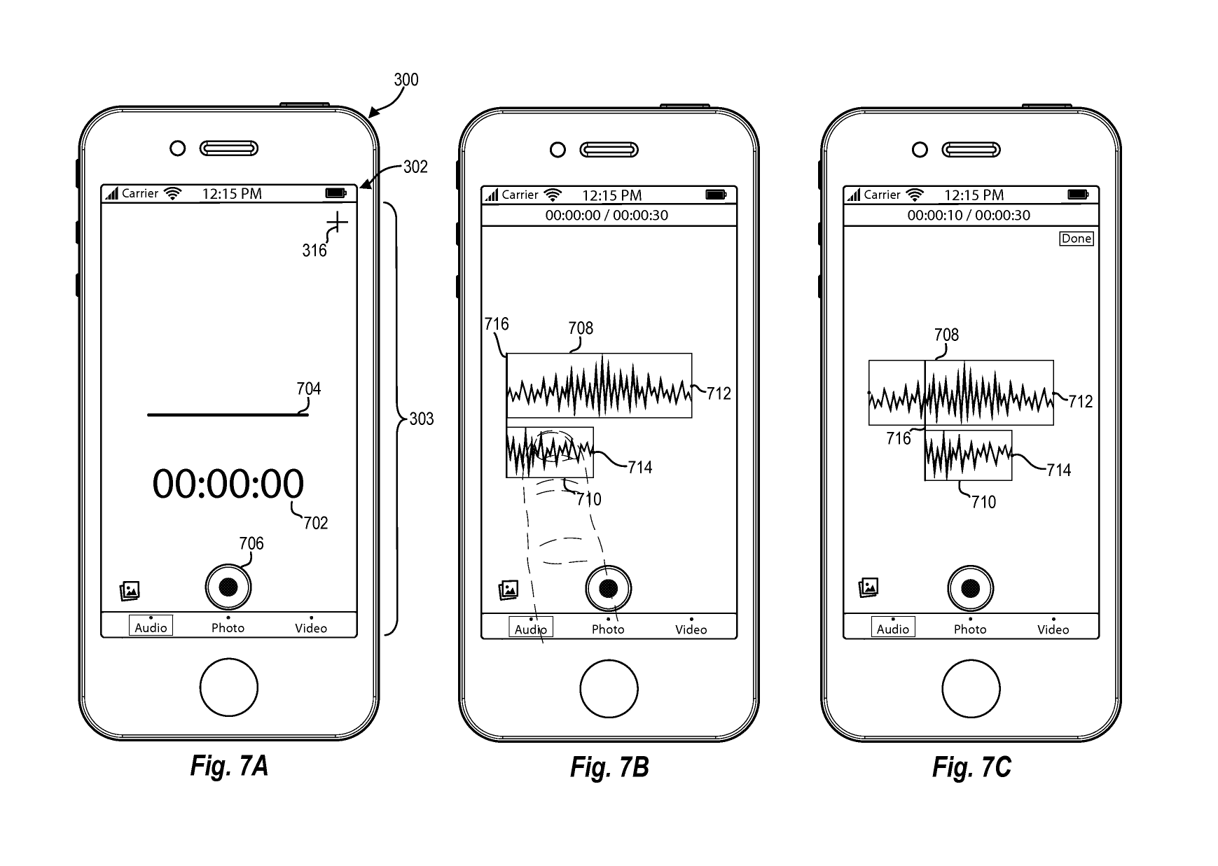

In addition to capturing video digital content items and video content enhancements, the communication system 200 can also capture audio (or other) digital content items and audio (or other) content enhancements. For example, FIGS. 7A-7C illustrate a user interface utilized by the communication system 200 in capturing or modifying audio digital content enhancements and/or audio content enhancements in accordance with one or more embodiments. As discussed, in one or more embodiments, the communication system 200 can provide a user interface as illustrated in FIGS. 7A-7C, upon user interaction with the content ribbon 315.

FIGS. 7A-7C illustrate the user interface 303 with components to facilitate in capturing or modifying an audio digital content item. In particular, in FIG. 7A the user interface 303 includes a timer element 702 (that can display the duration and location of an audio digital content item as it is captured) an audio graphical element 704 (that can display visual representations of an audio recording, such as an audio wave), and an audio capture element 706 (used to initiate, pause, and resume capturing).

FIG. 7B illustrates the user interface 303 upon selection of an audio digital content item and an audio content enhancement. In particular, FIG. 7B illustrates the user interface 303 with an audio digital content timeline 708, an audio content enhancement timeline 710, and a navigation bar 716. The timelines 708, 710 provide feedback regarding the characteristics of the digital content item and the content enhancement and permit modifications to the digital content item and/or content enhancement in relation to each other.

For example, as illustrated in FIGS. 7B and 7C, a user can interact with (e.g., press and drag) the content enhancement timeline 710, and the communication system 200 can modify the content enhancement such that the content enhancement begins and ends at a different time in relation to the digital content item. Thus, as shown in FIG. 7C, the communication system 200 modifies the audio content enhancement in relation to the digital content item so that it begins at 00:00:10 of the digital content item rather than at 00:00:00. Furthermore, a user can interact with trim elements 712, 714 to trim, lengthen, or otherwise modify the audio content enhancements.

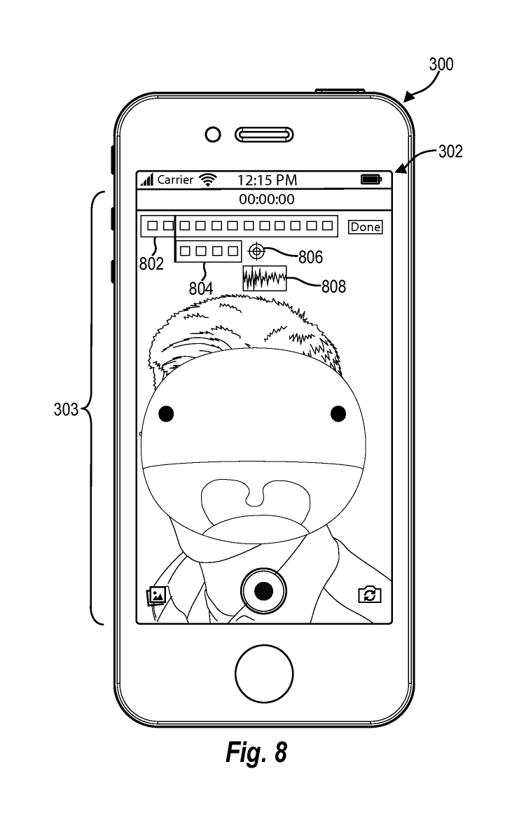

Although FIGS. 6A-6G and FIGS. 7A-7C illustrate embodiments that include video content enhancements with video digital content items and audio content enhancements with audio digital content items, the communication system 200 can utilize any type of content enhancement in conjunction with any type of digital content item. Thus, as shown in FIG. 8, the communication system 200 can capture a video content enhancement (represented as a video digital content timeline 802), capture a video content enhancement utilizing an image content enhancement with automatic modifications (represented as a video content enhancement timeline 704 with an icon 706), and provide an audio content enhancement (represented as an audio content enhancement timeline 708). Furthermore, as shown, the communication system 200 can provide feedback regarding the duration, start point, and end point, of a digital content item and multiple content enhancements.

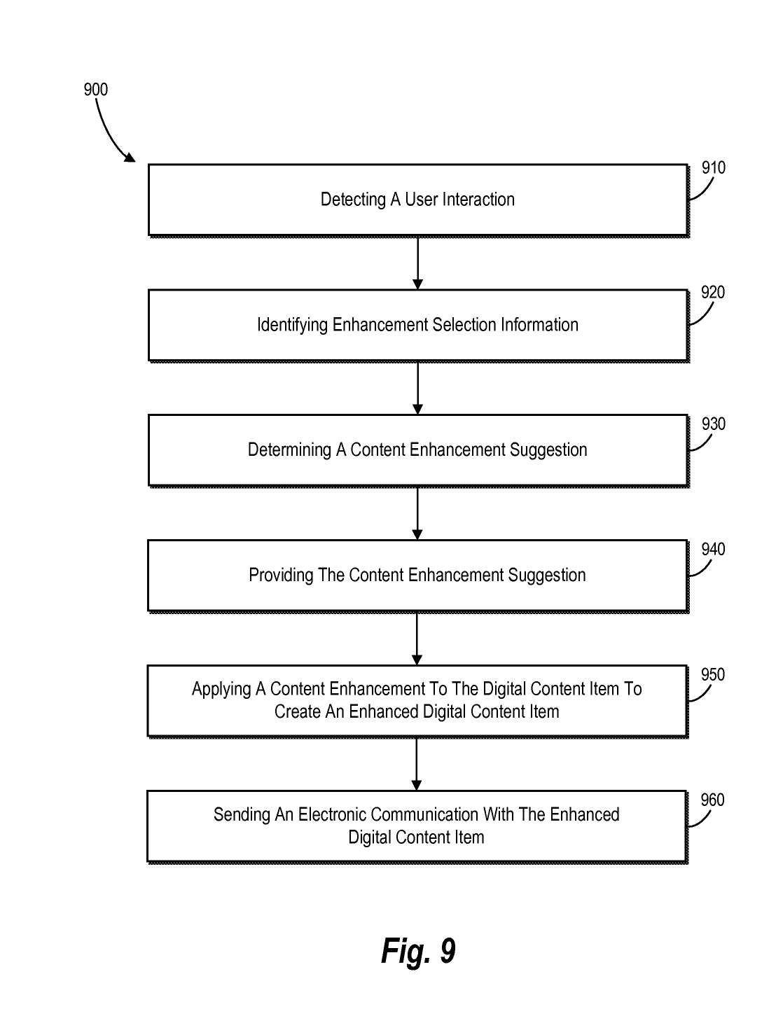

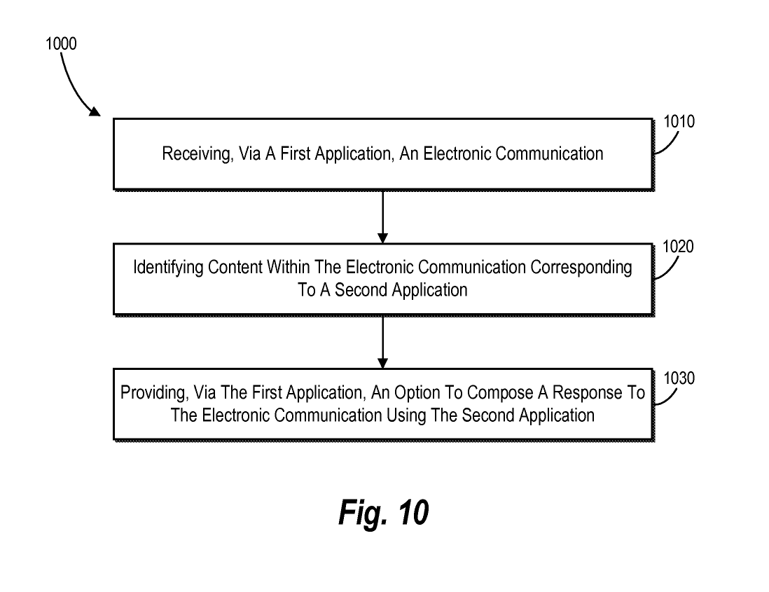

FIGS. 1-8, the corresponding text, and the examples, provide a number of different systems and devices that allows a user to facilitate electronic communication using content enhancements. In addition to the foregoing, embodiments can also be described in terms of flowcharts comprising acts and steps in a method for accomplishing a particular result. For example, FIGS. 9 and 10 illustrate flowcharts of exemplary methods in accordance with one or more embodiments of the present invention. The methods described in relation to FIGS. 9 and 10 may be performed with less or more steps/acts or the steps/acts may be performed in differing orders. Additionally, the steps/acts described herein may be repeated or performed in parallel with one another or in parallel with different instances of the same or similar steps/acts.

FIG. 9 illustrates a flowchart of a series of acts in a method 900 of facilitating electronic communication with a content enhancement in accordance with one or more embodiments of the present invention. In one or more embodiments, the method 900 is performed in a digital medium environment that includes the communication system 200. The electronic communication system 200 may provide a system that allows a user to apply one or more content enhancements to a digital content item and send the enhanced digital content item to a recipient. The method 900 is intended to be illustrative of one or more methods in accordance with the present disclosure, and is not intended to limit potential embodiments. Alternative embodiments can include additional, fewer, or different steps than those articulated in FIG. 9.

The method 900 includes an act 910 of detecting a user interaction. The act 910 can include detecting a user interaction indicating a desire to compose an electronic communication that includes a digital content item. In particular, the act 910 could include detecting a user interaction indicating a desire to compose an electronic communication that includes a digital content item and a content enhancement. For example, the act 910 could include detecting selection of an option to compose a response to an electronic communication containing a digital content item.

As illustrated in FIG. 9, the method 900 also includes an act 920 of identifying enhancement selection information. For example, the act 920 can include identifying enhancement selection information relating to an electronic communication. More specifically, the act 920 can also include identifying enhancement selection information relating to a digital content item, a content enhancement, user interest in a content enhancement, or user preference in a content enhancement. Furthermore, identifying enhancement selection information can also comprise detecting location information; detecting one or more features of the digital content item; detecting one or more characteristics of the user; accessing information associated with the user from a social graph, detecting contextual information; detecting the date; detecting the weather; or detecting the time.

The method 900 also includes, as shown in FIG. 9, an act 930 of determining a content enhancement suggestion. In particular, the act 930 can include determining, based on the enhancement selection information, a content enhancement suggestion. More specifically, determining a content enhancement suggestion can include analyzing enhancement selection information, identifying one or more topics associated with the content enhancement selection information, identifying one or more topics associated with a content enhancement, and comparing the one or more topics associated with the content enhancement selection information and the one or more topics associated with the enhancement selection information. Furthermore, determining a content enhancement suggestion can also include ranking enhancement selection information (and/or one or more topics) and weighting enhancement selection information (and/or one or more topics).

FIG. 9 also illustrates that the method 900 includes the act 940 of providing the content enhancement suggestion. In particular, the act 940 can include providing, to the user, the content enhancement suggestion. Providing the content enhancement suggestion can also include displaying the content enhancement suggestion in conjunction with the digital content item.

The method 900 also includes the act 950 of applying a content enhancement to the digital content item to create an enhanced digital content item. For example, the act 950 can also include applying, to the digital content item, a content enhancement corresponding to the content enhancement suggestion to create an enhanced digital content item. For instance, where the digital content item comprises a video sequence, applying the content enhancement suggestion to the digital content item to create an enhanced digital content item can comprise capturing, based on user input, a video content enhancement while presenting the video sequence over time and combining the video content enhancement and the video sequence to create an enhanced digital content item. The content enhancement can comprise a digital overlay, advertising content, or a link that when selected causes a client device to display a website.

As shown in FIG. 9, the method 900 also includes the act 960 of sending an electronic communication with the enhanced digital content item. The act 960 can also include sending the electronic communication with the enhanced digital content item to a recipient. Furthermore, in one embodiment, a first application on a client device provides the content enhancement suggestion and a second application on the client device sends the electronic communication.

FIG. 10 illustrates a flowchart of a series of acts in another method 1000 of facilitating electronic communication with a content enhancement in accordance with one or more embodiments of the present invention. The method 1000 includes an act 1010 of receiving, via a first application, an electronic communication. In particular, the act 1010 can include receiving, via a first application, an electronic communication containing a digital content item. The act 1010 can also include receiving, via a first application, an electronic containing a content enhancement.

As shown in FIG. 10, the method 1000 also includes the act 1020 of identifying content within the electronic communication corresponding to a second application. For example, the act 1020 can include identifying a content enhancement within the electronic communication corresponding to a content enhancement application.

FIG. 10 also illustrates that the method 1000 includes the act 1030 of, providing, via the first application, an option to compose a response to the electronic communication using the second application. In particular, the act 1030 can include providing, based on the content and via the first application, an option to compose a response to the electronic communication using the second application. For example, the act 1030 an include providing an option to compose a response to the electronic communication using a content enhancement application.

FIG. 11 illustrates, in block diagram form, an exemplary computing device 1100 that may be configured to perform one or more of the processes described above. One will appreciate that system 100, computing devices 102, 104, sever 108, system 200, client device 202 and server device 204 each comprise one or more computing devices in accordance with implementations of computing device 1100. As shown by FIG. 11, the computing device can comprise a processor 1102, a memory 1104, a storage device 1106, an I/O interface 1108, and a communication interface 1110, which may be communicatively coupled by way of communication infrastructure 1112. While an exemplary computing device 1100 is shown in FIG. 11, the components illustrated in FIG. 11 are not intended to be limiting. Additional or alternative components may be used in other embodiments. Furthermore, in certain embodiments, a computing device 1100 can include fewer components than those shown in FIG. 11. Components of computing device 1100 shown in FIG. 11 will now be described in additional detail.

In particular embodiments, processor 1102 includes hardware for executing instructions, such as those making up a computer program. As an example and not by way of limitation, to execute instructions, processor 1102 may retrieve (or fetch) the instructions from an internal register, an internal cache, memory 1104, or storage device 1106 and decode and execute them. In particular embodiments, processor 1102 may include one or more internal caches for data, instructions, or addresses. As an example and not by way of limitation, processor 1102 may include one or more instruction caches, one or more data caches, and one or more translation lookaside buffers (TLBs). Instructions in the instruction caches may be copies of instructions in memory 1104 or storage 1106.

Memory 1104 may be used for storing data, metadata, and programs for execution by the processor(s). Memory 1104 may include one or more of volatile and non-volatile memories, such as Random Access Memory (“RAM”), Read Only Memory (“ROM”), a solid state disk (“SSD”), Flash, Phase Change Memory (“PCM”), or other types of data storage. Memory 1104 may be internal or distributed memory.

Storage device 1106 includes storage for storing data or instructions. As an example and not by way of limitation, storage device 1106 can comprise a non-transitory storage medium described above. Storage device 1106 may include a hard disk drive (HDD), a floppy disk drive, flash memory, an optical disc, a magneto-optical disc, magnetic tape, or a Universal Serial Bus (USB) drive or a combination of two or more of these. Storage device 1106 may include removable or non-removable (or fixed) media, where appropriate. Storage device 1106 may be internal or external to the computing device 1100. In particular embodiments, storage device 1106 is non-volatile, solid-state memory. In other embodiments, Storage device 1106 includes read-only memory (ROM). Where appropriate, this ROM may be mask programmed ROM, programmable ROM (PROM), erasable PROM (EPROM), electrically erasable PROM (EEPROM), electrically alterable ROM (EAROM), or flash memory or a combination of two or more of these.

I/O interface 1108 allows a user to provide input to, receive output from, and otherwise transfer data to and receive data from computing device 1100. I/O interface 1108 may include a mouse, a keypad or a keyboard, a touch screen, a camera, an optical scanner, network interface, modem, other known I/O devices or a combination of such I/O interfaces. I/O interface 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interface 1108 is configured to provide graphical data to a display for presentation to a user. The graphical data may be representative of one or more graphical user interfaces and/or any other graphical content as may serve a particular implementation.

Communication interface 1110 can include hardware, software, or both. In any event, communication interface 1110 can provide one or more interfaces for communication (such as, for example, packet-based communication) between computing device 1100 and one or more other computing devices or networks. As an example and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI.

Additionally or alternatively, communication interface 1110 may facilitate communications with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, communication interface 1110 may facilitate communications with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination thereof.

Communication infrastructure 1112 may include hardware, software, or both that couples components of computing device 1100 to each other. As an example and not by way of limitation, communication infrastructure 1112 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination thereof.

As mentioned above, system 200 may be linked to and/or implemented within a social-networking system. A social-networking system may enable its users (such as persons or organizations) to interact with the system and with each other. The social-networking system may, with input from a user, create and store in the social-networking system a user profile associated with the user. The user profile may include demographic information, communication-channel information, and information on personal interests of the user. The social-networking system may also, with input from a user, create and store a record of relationships of the user with other users of the social-networking system, as well as provide services (e.g. wall posts, photo-sharing, event organization, messaging, games, or advertisements) to facilitate social interaction between or among users.

The social-networking system may store records of users and relationships between users in a social graph comprising a plurality of nodes and a plurality of edges connecting the nodes. The nodes may comprise a plurality of user nodes and a plurality of concept nodes. A user node of the social graph may correspond to a user of the social-networking system. A user may be an individual (human user), an entity (e.g., an enterprise, business, or third party application), or a group (e.g., of individuals or entities). A user node corresponding to a user may comprise information provided by the user and information gathered by various systems, including the social-networking system.

For example, the user may provide his or her name, profile picture, city of residence, contact information, birth date, gender, marital status, family status, employment, educational background, preferences, interests, and other demographic information to be included in the user node. Each user node of the social graph may have a corresponding web page (typically known as a profile page). In response to a request including a user name, the social-networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

A concept node may correspond to a concept of the social-networking system. For example, a concept can represent a real-world entity, such as a movie, a song, a sports team, a celebrity, a group, a restaurant, or a place or a location. An administrative user of a concept node corresponding to a concept may create or update the concept node by providing information of the concept (e.g., by filling out an online form), causing the social-networking system to associate the information with the concept node. For example and without limitation, information associated with a concept can include a name or a title, one or more images (e.g., an image of cover page of a book), a web site (e.g., an URL address) or contact information (e.g., a phone number, an email address). Each concept node of the social graph may correspond to a web page. For example, in response to a request including a name, the social-networking system can access a concept node corresponding to the name, and construct a web page including the name and other information associated with the concept.

An edge between a pair of nodes may represent a relationship between the pair of nodes. For example, an edge between two user nodes can represent a friendship between two users. For another example, the social-networking system may construct a web page (or a structured document) of a concept node (e.g., a restaurant, a celebrity), incorporating one or more selectable buttons (e.g., “like”, “check in”) in the web page. A user can access the page using a web browser hosted by the user's client device and select a selectable button, causing the client device to transmit to the social-networking system a request to create an edge between a user node of the user and a concept node of the concept, indicating a relationship between the user and the concept (e.g., the user checks in to a restaurant, or the user “likes” a celebrity).

As an example, a user may provide (or change) his or her city of residence, causing the social-networking system to create an edge between a user node corresponding to the user and a concept node corresponding to the city declared by the user as his or her city of residence. In addition, the degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.”

A social-networking system may support a variety of applications, such as photo sharing, on-line calendars and events, gaming, instant messaging, and advertising. For example, the social-networking system may also include media sharing capabilities. Also, the social-networking system may allow users to post photographs and other multimedia files to a user's profile page (typically known as “wall posts” or “timeline posts”) or in a photo album, both of which may be accessible to other users of the social-networking system depending upon the user's configured privacy settings. The social-networking system may also allow users to configure events. For example, a first user may configure an event with attributes including time and date of the event, location of the event and other users invited to the event. The invited users may receive invitations to the event and respond (such as by accepting the invitation or declining it). Furthermore, the social-networking system may allow users to maintain a personal calendar. Similarly to events, the calendar entries may include times, dates, locations and identities of other users.

FIG. 12 illustrates an example network environment of a social-networking system. In particular embodiments, a social-networking system 1202 may comprise one or more data stores. In particular embodiments, the social-networking system 1202 may store a social graph comprising user nodes, concept nodes, and edges between nodes as described earlier. Each user node may comprise one or more data objects corresponding to information associated with or describing a user. Each concept node may comprise one or more data objects corresponding to information associated with a concept. Each edge between a pair of nodes may comprise one or more data objects corresponding to information associated with a relationship between users (or between a user and a concept, or between concepts) corresponding to the pair of nodes.

In particular embodiments, the social-networking system 1202 may comprise one or more computing devices (e.g., servers) hosting functionality directed to operation of the social-networking system 1202. A user of the social-networking system 1202 may access the social-networking system 1202 using a client device such as client device 1206. In particular embodiments, the client device 1206 can interact with the social-networking system 1202 through a network 1204.

The client device 1206 may be a desktop computer, a laptop computer, a tablet computer, a personal digital assistant (PDA), an in- or out-of-car navigation system, a smart phone or other cellular or mobile phone, or a mobile gaming device, other mobile device, or other suitable computing devices. Client device 1206 may execute one or more client applications, such as a web browser (e.g., Microsoft Windows Internet Explorer, Mozilla Firefox, Apple Safari, Google Chrome, Opera, etc.) or a native or special-purpose client application (e.g., Facebook for iPhone or iPad, Facebook for Android, etc.), to access and view content over network 1204.

Network 1204 may represent a network or collection of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which client devices 1206 may access the social-networking system 1202.

While these methods, systems, and user interfaces utilize both publicly available information as well as information provided by users of the social-networking system, all use of such information is to be explicitly subject to all privacy settings of the involved users and the privacy policy of the social-networking system as a whole.

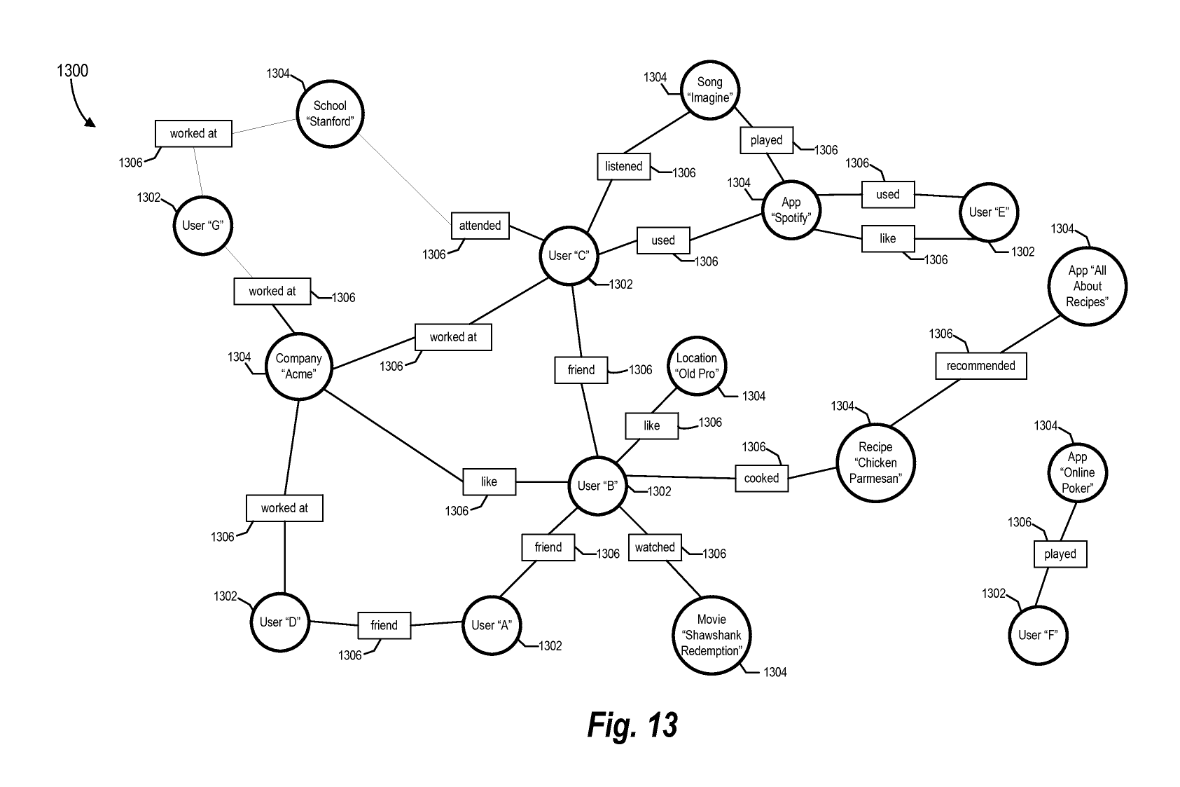

FIG. 13 illustrates example social graph 1300. In particular embodiments, social networking system 2402 may store one or more social graphs 1300 in one or more data stores. In particular embodiments, social graph 1300 may include multiple nodes—which may include multiple user nodes 1302 or multiple concept nodes 1304—and multiple edges 1306 connecting the nodes. Example social graph 1300 illustrated in FIG. 13 is shown, for didactic purposes, in a two-dimensional visual map representation. In particular embodiments, a social networking system 2402, client system 2406, or third-party system 2408 may access social graph 1300 and related social-graph information for suitable applications. The nodes and edges of social graph 1300 may be stored as data objects, for example, in a data store (such as a social-graph database). Such a data store may include one or more searchable or query able indexes of nodes or edges of social graph 1300.

In particular embodiments, a user node 1302 may correspond to a user of social networking system 2402. As an example and not by way of limitation, a user may be an individual (human user), an entity (e.g., an enterprise, business, or third-party application), or a group (e.g., of individuals or entities) that interacts or communicates with or over social networking system 2402. In particular embodiments, when a user registers for an account with social networking system 2402, social networking system 2402 may create a user node 1302 corresponding to the user, and store the user node 1302 in one or more data stores. Users and user nodes 1302 described herein may, where appropriate, refer to registered users and user nodes 1302 associated with registered users. In addition or as an alternative, users and user nodes 1302 described herein may, where appropriate, refer to users that have not registered with social networking system 2402. In particular embodiments, a user node 1302 may be associated with information provided by a user or information gathered by various systems, including social networking system 2402. As an example and not by way of limitation, a user may provide his or her name, profile picture, contact information, birth date, sex, marital status, family status, employment, education background, preferences, interests, or other demographic information. Each user node of the social graph may have a corresponding web page (typically known as a profile page). In response to a request including a user name, the social networking system can access a user node corresponding to the user name, and construct a profile page including the name, a profile picture, and other information associated with the user. A profile page of a first user may display to a second user all or a portion of the first user's information based on one or more privacy settings by the first user and the relationship between the first user and the second user.

In particular embodiments, a concept node 1304 may correspond to a concept. As an example and not by way of limitation, a concept may correspond to a place (such as, for example, a movie theater, restaurant, landmark, or city); a website (such as, for example, a website associated with social-network system 2402 or a third-party website associated with a web-application server); an entity (such as, for example, a person, business, group, sports team, or celebrity); a resource (such as, for example, an audio file, video file, digital photo, text file, structured document, or application) which may be located within social networking system 2402 or on an external server, such as a web-application server; real or intellectual property (such as, for example, a sculpture, painting, movie, game, song, idea, photograph, or written work); a game; an activity; an idea or theory; another suitable concept; or two or more such concepts. A concept node 1304 may be associated with information of a concept provided by a user or information gathered by various systems, including social networking system 2402. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 1304 may be associated with one or more data objects corresponding to information associated with concept node 1304. In particular embodiments, a concept node 1304 may correspond to one or more webpages.

In particular embodiments, a node in social graph 1300 may represent or be represented by a webpage (which may be referred to as a “profile page”). Profile pages may be hosted by or accessible to social networking system 2402. Profile pages may also be hosted on third-party websites associated with a third-party server 2408. As an example and not by way of limitation, a profile page corresponding to a particular external webpage may be the particular external webpage and the profile page may correspond to a particular concept node 1304. Profile pages may be viewable by all or a selected subset of other users. As an example and not by way of limitation, a user node 1302 may have a corresponding user-profile page in which the corresponding user may add content, make declarations, or otherwise express himself or herself. As another example and not by way of limitation, a concept node 1304 may have a corresponding concept-profile page in which one or more users may add content, make declarations, or express themselves, particularly in relation to the concept corresponding to concept node 1304.

In particular embodiments, a concept node 1304 may represent a third-party webpage or resource hosted by a third-party system 2408. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check in,” “eat,” “recommend,” or another suitable action or activity. A user viewing the third-party webpage may perform an action by selecting one of the icons (e.g., “eat”), causing a client system 2406 to send to social networking system 2402 a message indicating the user's action. In response to the message, social networking system 2402 may create an edge (e.g., an “eat” edge) between a user node 1302 corresponding to the user and a concept node 1304 corresponding to the third-party webpage or resource and store edge 1306 in one or more data stores.

In particular embodiments, a pair of nodes in social graph 1300 may be connected to each other by one or more edges 1306. An edge 1306 connecting a pair of nodes may represent a relationship between the pair of nodes. In particular embodiments, an edge 1306 may include or represent one or more data objects or attributes corresponding to the relationship between a pair of nodes. As an example and not by way of limitation, a first user may indicate that a second user is a “friend” of the first user. In response to this indication, social networking system 2402 may send a “friend request” to the second user. If the second user confirms the “friend request,” social networking system 2402 may create an edge 1306 connecting the first user's user node 1302 to the second user's user node 1302 in social graph 1300 and store edge 1306 as social-graph information in one or more of data stores. In the example of FIG. 13, social graph 1300 includes an edge 1306 indicating a friend relation between user nodes 1302 of user “A” and user “B” and an edge indicating a friend relation between user nodes 1302 of user “C” and user “B.” Although this disclosure describes or illustrates particular edges 1306 with particular attributes connecting particular user nodes 1302, this disclosure contemplates any suitable edges 1306 with any suitable attributes connecting user nodes 1302. As an example and not by way of limitation, an edge 1306 may represent a friendship, family relationship, business or employment relationship, fan relationship, follower relationship, visitor relationship, subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 1300 by one or more edges 1306.

In particular embodiments, an edge 1306 between a user node 1302 and a concept node 1304 may represent a particular action or activity performed by a user associated with user node 1302 toward a concept associated with a concept node 1304. As an example and not by way of limitation, as illustrated in FIG. 13, a user may “like,” “attended,” “played,” “listened,” “cooked,” “worked at,” or “watched” a concept, each of which may correspond to a edge type or subtype. A concept-profile page corresponding to a concept node 1304 may include, for example, a selectable “check in” icon (such as, for example, a clickable “check in” icon) or a selectable “add to favorites” icon. Similarly, after a user clicks these icons, social networking system 2402 may create a “favorite” edge or a “check in” edge in response to a user's action corresponding to a respective action. As another example and not by way of limitation, a user (user “C”) may listen to a particular song (“Ramble On”) using a particular application (SPOTIFY, which is an online music application). In this case, social networking system 2402 may create a “listened” edge 1306 and a “used” edge (as illustrated in FIG. 13) between user nodes 1302 corresponding to the user and concept nodes 1304 corresponding to the song and application to indicate that the user listened to the song and used the application. Moreover, social networking system 2402 may create a “played” edge 1306 (as illustrated in FIG. 13) between concept nodes 1304 corresponding to the song and the application to indicate that the particular song was played by the particular application. In this case, “played” edge 1306 corresponds to an action performed by an external application (SPOTIFY) on an external audio file (the song “Imagine”). Although this disclosure describes particular edges 1306 with particular attributes connecting user nodes 1302 and concept nodes 1304, this disclosure contemplates any suitable edges 1306 with any suitable attributes connecting user nodes 1302 and concept nodes 1304. Moreover, although this disclosure describes edges between a user node 1302 and a concept node 1304 representing a single relationship, this disclosure contemplates edges between a user node 1302 and a concept node 1304 representing one or more relationships. As an example and not by way of limitation, an edge 1306 may represent both that a user likes and has used at a particular concept. Alternatively, another edge 1306 may represent each type of relationship (or multiples of a single relationship) between a user node 1302 and a concept node 1304 (as illustrated in FIG. 13 between user node 1302 for user “E” and concept node 1304 for “SPOTIFY”).

In particular embodiments, social networking system 2402 may create an edge 1306 between a user node 1302 and a concept node 1304 in social graph 1300. As an example and not by way of limitation, a user viewing a concept-profile page (such as, for example, by using a web browser or a special-purpose application hosted by the user's client system 2406) may indicate that he or she likes the concept represented by the concept node 1304 by clicking or selecting a “Like” icon, which may cause the user's client system 2406 to send to social networking system 2402 a message indicating the user's liking of the concept associated with the concept-profile page. In response to the message, social networking system 2402 may create an edge 1306 between user node 1302 associated with the user and concept node 1304, as illustrated by “like” edge 1306 between the user and concept node 1304. In particular embodiments, social networking system 2402 may store an edge 1306 in one or more data stores. In particular embodiments, an edge 1306 may be automatically formed by social networking system 2402 in response to a particular user action. As an example and not by way of limitation, if a first user uploads a picture, watches a movie, or listens to a song, an edge 1306 may be formed between user node 1302 corresponding to the first user and concept nodes 1304 corresponding to those concepts. Although this disclosure describes forming particular edges 1306 in particular manners, this disclosure contemplates forming any suitable edges 1306 in any suitable manner.

In particular embodiments, an advertisement may be text (which may be HTML-linked), one or more images (which may be HTML-linked), one or more videos, audio, one or more ADOBE FLASH files, a suitable combination of these, or any other suitable advertisement in any suitable digital format presented on one or more webpages, in one or more e-mails, or in connection with search results requested by a user. In addition or as an alternative, an advertisement may be one or more sponsored stories (e.g., a news-feed or ticker item on social networking system 2402). A sponsored story may be a social action by a user (such as “liking” a page, “liking” or commenting on a post on a page, RSVPing to an event associated with a page, voting on a question posted on a page, checking in to a place, using an application or playing a game, or “liking” or sharing a website) that an advertiser promotes, for example, by having the social action presented within a pre-determined area of a profile page of a user or other page, presented with additional information associated with the advertiser, bumped up or otherwise highlighted within news feeds or tickers of other users, or otherwise promoted. The advertiser may pay to have the social action promoted. As an example and not by way of limitation, advertisements may be included among the search results of a search-results page, where sponsored content is promoted over non-sponsored content.

In particular embodiments, an advertisement may be requested for display within social-networking-system webpages, third-party webpages, or other pages. An advertisement may be displayed in a dedicated portion of a page, such as in a banner area at the top of the page, in a column at the side of the page, in a GUI of the page, in a pop-up window, in a drop-down menu, in an input field of the page, over the top of content of the page, or elsewhere with respect to the page. In addition or as an alternative, an advertisement may be displayed within an application. An advertisement may be displayed within dedicated pages, requiring the user to interact with or watch the advertisement before the user may access a page or utilize an application. The user may, for example view the advertisement through a web browser.

A user may interact with an advertisement in any suitable manner. The user may click or otherwise select the advertisement. By selecting the advertisement, the user may be directed to (or a browser or other application being used by the user) a page associated with the advertisement. At the page associated with the advertisement, the user may take additional actions, such as purchasing a product or service associated with the advertisement, receiving information associated with the advertisement, or subscribing to a newsletter associated with the advertisement. An advertisement with audio or video may be played by selecting a component of the advertisement (like a “play button”). Alternatively, by selecting the advertisement, social networking system 2402 may execute or modify a particular action of the user.

An advertisement may also include social-networking-system functionality that a user may interact with. As an example and not by way of limitation, an advertisement may enable a user to “like” or otherwise endorse the advertisement by selecting an icon or link associated with endorsement. As another example and not by way of limitation, an advertisement may enable a user to search (e.g., by executing a query) for content related to the advertiser. Similarly, a user may share the advertisement with another user (e.g., through social networking system 2402) or RSVP (e.g., through social networking system 2402) to an event associated with the advertisement. In addition or as an alternative, an advertisement may include social-networking-system context directed to the user. As an example and not by way of limitation, an advertisement may display information about a friend of the user within social networking system 2402 who has taken an action associated with the subject matter of the advertisement.

In particular embodiments, social networking system 2402 may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems 2408 or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social networking system 2402 may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part a the history of the user's actions. Coefficients may be used to predict any number of actions, which may be within or outside of the online social network. As an example and not by way of limitation, these actions may include various types of communications, such as sending messages, posting content, or commenting on content; various types of a observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social networking system 2402 may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 250%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social networking system 2402 may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social networking system 2402 may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social networking system 2402 may calculate a coefficient based on a user's actions. Social networking system 2402 may monitor such actions on the online social network, on a third-party system 2408, on other suitable systems, or any combination thereof. Any suitable type of user actions may be tracked or monitored. Typical user actions include viewing profile pages, creating or posting content, interacting with content, joining groups, listing and confirming attendance at events, checking-in at locations, liking particular pages, creating pages, and performing other tasks that facilitate social action. In particular embodiments, social networking system 2402 may calculate a coefficient based on the user's actions with particular types of content. The content may be associated with the online social network, a third-party system 2408, or another suitable system. The content may include users, profile pages, posts, news stories, headlines, instant messages, chat room conversations, emails, advertisements, pictures, video, music, other suitable objects, or any combination thereof. Social networking system 2402 may analyze a user's actions to determine whether one or more of the actions indicate an affinity for subject matter, content, other users, and so forth. As an example and not by way of limitation, if a user may make frequently posts content related to “coffee” or variants thereof, social networking system 2402 may determine the user has a high coefficient with respect to the concept “coffee.” Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social networking system 2402 may calculate a coefficient based on the type of relationship between particular objects. Referencing the social graph 1300, social networking system 2402 may analyze the number and/or type of edges 1306 connecting particular user nodes 1302 and concept nodes 1304 when calculating a coefficient. As an example and not by way of limitation, user nodes 1302 that are connected by a spouse-type edge (representing that the two users are married) may be assigned a higher coefficient than a user nodes 1302 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in first photo, but merely likes a second photo, social networking system 2402 may determine that the user has a higher coefficient with respect to the first photo than the second photo because having a tagged-in-type relationship with content may be assigned a higher weight and/or rating than having a like-type relationship with content. In particular embodiments, social networking system 2402 may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social networking system 2402 may determine that the first user should also have a relatively high coefficient for the particular object. In particular embodiments, the coefficient may be based on the degree of separation between particular objects. Degree of separation between any two nodes is defined as the minimum number of hops required to traverse the social graph from one node to the other. A degree of separation between two nodes can be considered a measure of relatedness between the users or the concepts represented by the two nodes in the social graph. For example, two users having user nodes that are directly connected by an edge (i.e., are first-degree nodes) may be described as “connected users” or “friends.” Similarly, two users having user nodes that are connected only through another user node (i.e., are second-degree nodes) may be described as “friends of friends.” The lower coefficient may represent the decreasing likelihood that the first user will share an interest in content objects of the user that is indirectly connected to the first user in the social graph 1300. As an example and not by way of limitation, social-graph entities that are closer in the social graph 1300 (i.e., fewer degrees of separation) may have a higher coefficient than entities that are further apart in the social graph 1300.

In particular embodiments, social networking system 2402 may calculate a coefficient based on location information. Objects that are geographically closer to each other may be considered to be more related, or of more interest, to each other than more distant objects. In particular embodiments, the coefficient of a user towards a particular object may be based on the proximity of the object's location to a current location associated with the user (or the location of a client system 2406 of the user). A first user may be more interested in other users or concepts that are closer to the first user. As an example and not by way of limitation, if a user is one mile from an airport and two miles from a gas station, social networking system 2402 may determine that the user has a higher coefficient for the airport than the gas station based on the proximity of the airport to the user.

In particular embodiments, social networking system 2402 may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social networking system 2402 may provide information that is relevant to user's interests and current circumstances, increasing the likelihood that they will find such information of interest. In particular embodiments, social networking system 2402 may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social networking system 2402 may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social networking system 2402 may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system 2408 (e.g., via an API or other communication channel), or from another suitable system. In response to the request, social networking system 2402 may calculate the coefficient (or access the coefficient information if it has previously been calculated and stored). In particular embodiments, social networking system 2402 may measure an affinity with respect to a particular process. Different processes (both internal and external to the online social network) may request a coefficient for a particular object or set of objects. Social networking system 2402 may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed Aug. 8, 2006, U.S. patent application Ser. No. 12/977,027, filed Dec. 22, 2010, U.S. patent application Ser. No. 12/978,265, filed Dec. 23, 2010, and U.S. patent application Ser. No. 13/632,869, field Oct. 1, 2012, each of which is incorporated by reference in their entirety.

In particular embodiments, one or more of the content objects of the online social network may be associated with a privacy setting. The privacy settings (or “access settings”) for an object may be stored in any suitable manner, such as, for example, in association with the object, in an index on an authorization server, in another suitable manner, or any combination thereof. A privacy setting of an object may specify how the object (or particular information associated with an object) can be accessed (e.g., viewed or shared) using the online social network. Where the privacy settings for an object allow a particular user to access that object, the object may be described as being “visible” with respect to that user. As an example and not by way of limitation, a user of the online social network may specify privacy settings for a user-profile page identify a set of users that may access the work experience information on the user-profile page, thus excluding other users from accessing the information. In particular embodiments, the privacy settings may specify a “blocked list” of users that should not be allowed to access certain information associated with the object. In other words, the blocked list may specify one or more users or entities for which an object is not visible. As an example and not by way of limitation, a user may specify a set of users that may not access photos albums associated with the user, thus excluding those users from accessing the photo albums (while also possibly allowing certain users not within the set of users to access the photo albums). In particular embodiments, privacy settings may be associated with particular social-graph elements. Privacy settings of a social-graph element, such as a node or an edge, may specify how the social-graph element, information associated with the social-graph element, or content objects associated with the social-graph element can be accessed using the online social network. As an example and not by way of limitation, a particular concept node 1304 corresponding to a particular photo may have a privacy setting specifying that the photo may only be accessed by users tagged in the photo and their friends. In particular embodiments, privacy settings may allow users to opt in or opt out of having their actions logged by social networking system 2402 or shared with other systems (e.g., third-party system 2408). In particular embodiments, the privacy settings associated with an object may specify any suitable granularity of permitted access or denial of access. As an example and not by way of limitation, access or denial of access may be specified for particular users (e.g., only me, my roommates, and my boss), users within a particular degrees-of-separation (e.g., friends, or friends-of-friends), user groups (e.g., the gaming club, my family), user networks (e.g., employees of particular employers, students or alumni of particular university), all users (“public”), no users (“private”), users of third-party systems 2408, particular applications (e.g., third-party applications, external websites), other suitable users or entities, or any combination thereof. Although this disclosure describes using particular privacy settings in a particular manner, this disclosure contemplates using any suitable privacy settings in any suitable manner.

In particular embodiments, one or more servers may be authorization/privacy servers for enforcing privacy settings. In response to a request from a user (or other entity) for a particular object stored in a data store, social networking system 2402 may send a request to the data store for the object. The request may identify the user associated with the request and may only be sent to the user (or a client system 2406 of the user) if the authorization server determines that the user is authorized to access the object based on the privacy settings associated with the object. If the requesting user is not authorized to access the object, the authorization server may prevent the requested object from being retrieved from the data store, or may prevent the requested object from be sent to the user. In the search query context, an object may only be generated as a search result if the querying user is authorized to access the object. In other words, the object must have a visibility that is visible to the querying user. If the object has a visibility that is not visible to the user, the object may be excluded from the search results. Although this disclosure describes enforcing privacy settings in a particular manner, this disclosure contemplates enforcing privacy settings in any suitable manner.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A method comprising:
detecting a user interaction indicating a desire to compose an electronic communication that includes a digital content item;
identifying, by at least one processor, enhancement selection information relating to the electronic communication;
determining, by the at least one processor and based on the enhancement selection information, a content enhancement suggestion;
providing, to the user, the content enhancement suggestion;
applying, to the digital content item, a content enhancement corresponding to the content enhancement suggestion to create an enhanced digital content item; and
sending the electronic communication with the enhanced digital content item to a recipient.

2. The method of claim 1, wherein the content enhancement comprises a digital overlay.

3. The method of claim 1, wherein the content enhancement comprises advertising content.

4. The method of claim 1, wherein the content enhancement comprises a link that when selected causes a client device to display a website.

5. The method of claim 1, further comprising detecting location information, wherein identifying enhancement selection information comprises identifying the location information.

6. The method of claim 1, further comprising detecting one or more features of the digital content item, wherein identifying enhancement selection information comprises identifying the one or more features of the digital content item.

7. The method of claim 1, further comprising detecting one or more characteristics of the user, wherein identifying enhancement selection information comprises identifying the one or more characteristics of the user.

8. The method of claim 1, further comprising accessing information associated with the user from a social-graph, wherein identifying enhancement selection information comprises identifying the information associated with the user from the social-graph.

9. The method of claim 1, further comprising detecting contextual information, wherein identifying enhancement selection information comprises identifying the contextual information.

10. The method of claim 1, wherein a first application on a client device provides the content enhancement suggestion and a second application on the client device sends the electronic communication.

11. The method of claim 1 wherein the digital content item comprises a video sequence and wherein applying the content enhancement corresponding to the content enhancement suggestion to the digital content item to create the enhanced digital content item comprises:
capturing, based on user input, a video content enhancement while presenting the video sequence over time; and
combining the video content enhancement and the video sequence to create the enhanced digital content item.

12. A system comprising:
at least one processor;
at least one non-transitory computer readable storage medium storing instructions thereon, that, when executed by the at least one processor, cause the system to:
detect a user interaction indicating a desire to compose an electronic communication that includes a digital content item;
identify enhancement selection information relating to the electronic communication;
determine, based on the enhancement selection information, a content enhancement suggestion;
provide, to the user, the content enhancement suggestion;
apply, to the digital content item, a content enhancement corresponding to the content enhancement suggestion to create an enhanced digital content item; and
send the electronic communication with the enhanced digital content item to a recipient.

13. The system of claim 12, wherein the content enhancement comprises one or more of the following: a digital overlay, advertising content, or a link that when selected causes a client device to display a website.

14. The system of claim 12, wherein identifying enhancement selection information comprises detecting one or more of the following: location information, one or more features of the digital content item, one or more characteristics of the user, information from a social-graph associated with the user, or contextual information.

15. The system of claim 12, further comprising instructions that, when executed by the at least one processor, cause the system to:
cause a first application on a client device to provide the content enhancement suggestion; and
cause a second application on the client device to send the electronic communication.

16. The system of claim 12, wherein the digital content item comprises a video sequence and wherein applying the content enhancement corresponding to the content enhancement suggestion to the digital content item to create the enhanced digital content item, and further comprising instructions that, when executed by the at least one processor, causes the system to:
capture, based on user input, a video content enhancement while presenting the video sequence over time; and
combine the video content enhancement and the video sequence to create the enhanced digital content item.

17. A non-transitory computer readable medium storing instructions thereon that, when executed by at least one processor, cause a computer system to:
detect a user interaction indicating a desire to compose an electronic communication that includes a digital content item;
identify enhancement selection information relating to the electronic communication;
determine, based on the enhancement selection information, a content enhancement suggestion;
provide, to the user, the content enhancement suggestion;
apply, to the digital content item, a content enhancement corresponding to the content enhancement suggestion to create an enhanced digital content item; and
send the electronic communication with the enhanced digital content item to a recipient.

18. The non-transitory computer readable medium of claim 12, wherein the content enhancement comprises one or more of the following: a digital overlay, advertising content, or a link that when selected causes a client device to display a website.

19. The non-transitory computer readable medium of claim 12, wherein identifying enhancement selection information comprises detecting one or more of the following: location information, one or more features of the digital content item, one or more characteristics of the user, information from a social-graph associated with the user, or contextual information.

20. The non-transitory computer readable medium of claim 12, further comprising instructions that, when executed by the at least one processor, cause the computer system to:
cause a first application on a client device to provide the content enhancement suggestion; and
cause a second application on the client device to send the electronic communication.
